(19) United States
(12) Patent Application Publication
(10) Pub. No.: US 2021/0157895 A1
(43) Pub. Date: May 27, 2021

(54) INFORMATION PROCESSING METHOD, INFORMATION DISPLAY METHOD, NON-TRANSITORY COMPUTER READABLE STORAGE MEDIUM, TERMINAL AND SERVER

(71) Applicant: LINE Corporation, Tokyo (JP)

(72) Inventors: Luyou YANG, Tokyo (JP); Zhu WANG, Tokyo (JP)

(73) Assignee: LINE Corporation, Tokyo (JP)

(21) Appl. No.: 17/167,535

(22) Filed: Feb. 4, 2021

Related U.S. Application Data
(63) Continuation of application No. PCT/JP2018/043541, filed on Nov. 27, 2018.

(30) Foreign Application Priority Data
Sep. 10, 2018 (JP) 2018-168894

(51) Int. Cl. G06F 21/36; G06K 7/14; G06Q 30/02

(52) U.S. Cl. CPC G06F 21/36; G06Q 30/0258; G06K 7/1417

(57) ABSTRACT

An information processing method to be carried out by a terminal including controlling a code reader to read code information displayed on a display device, the code reader corresponding to the code information and installed in the terminal, the code information being for a user authentication enabling an obtaining information provided by a first server, controlling transmission of information related to the code reader to the first server, controlling reception of information related to a service that manages user information from the first server based on the information related to the code reader, controlling communication with a second server of the service based on the information related to the service, and controlling execution a process related to an authentication of a user of the terminal based on a communication result with the second server.

### CROSS-REFERENCE TO RELATED APPLICATIONS

This application is a continuation of, and claims the benefit of priority under 35 U.S.C. §§ 120 and 365(c) from PCT International Application No. PCT/JP2018/043541, which has an International filing date of Nov. 27, 2018 and designates the United States of America, which claims priority to Japanese Patent Application Nos. 2018-168894, filed on Sep. 10, 2018 in the Japanese Patent Office (JPO), the entire disclosure of each of which is incorporated herein by reference.

### FIELD OF THE INVENTION

The present disclosure relates to information processing methods, information display methods, non-transitory computer readable storage mediums, terminals, and/or servers.

### BACKGROUND

Electronic Commerce (EC) that is a commercial trade utilizing the Internet is widely known. A scheme of executing a personal authentication of an EC applicant who applies for the EC has been known. However, such scheme may be inconvenient in some cases regarding the EC.

### SUMMARY

According to an example embodiment, an information processing method to be carried out by a terminal includes controlling, by a processor of the terminal, a code reader to read code information displayed on a display device, the code reader corresponding to the code information and installed in the terminal, the code information being for a user authentication enabling obtaining information provided by a first server, controlling, by the processor, transmission of information related to the code reader to the first server, controlling, by the processor, reception of information related to a service that manages user information from the first server based on the information related to the code reader, controlling, by the processor, communication with a second server of the service based on the information related to the service, and controlling, by the processor, execution a process related to an authentication of a user of the terminal based on a communication result with the second server.

According to an example embodiment, a non-transitory computer-readable recording medium storing a program that, when executed by a processor, causes a terminal including the processor to perform information processing method is provided. The method includes reading code information displayed on a display device by a code reader corresponding to the code information and installed in the terminal, the code information being for a user authentication enabling obtaining information provided by a first server, transmitting information related to the code reader to the first server, receiving information related to a service that manages user information from the first server based on the information related to the code reader, communicating with a second server of the service based on the information related to the service, and executing a process related to an authentication of a user of the terminal based on a communication result with the second server.

According to an example embodiment, a terminal includes a memory configured to a program, and one or more processors configured to execute the program such that the one or more processors are configured to cause the terminal to read code information displayed on a display device by a code reader corresponding to the code information and installed in the terminal, the code information being for a user authentication enabling obtaining information provided by a first server, transmit information related to the code reader to the first server, receive information related to a service that manages user information from the first server based on the information related to the code reader, communicate with a second server of the service based on the information related to the service, and execute a process related to the authentication of a user of the terminal based on a communication result with the second server.

### BRIEF DESCRIPTION OF THE DRAWINGS

FIG. 1 is a diagram illustrating an example structure of a communication system according to an example embodiment;

FIG. 2 is a diagram illustrating example functions accomplished by a control device of a terminal according to a first example embodiment;

FIG. 3 is a diagram illustrating example information stored in a storage of the terminal according to the first example embodiment;

FIG. 4 is a diagram illustrating an example structure of a personal computer according to the first example embodiment;

FIG. 5 is a diagram illustrating an example structure of an EC server according to the first example embodiment;

FIG. 6 is a diagram illustrating example EC user data according to the first example embodiment;

FIG. 7 is a diagram illustrating example login management data according to the first example embodiment;

FIG. 8 is a diagram illustrating example communication management data according to the first example embodiment;

FIG. 9 is a diagram illustrating example functions accomplished by a control device of an IMS server according to the first example embodiment;

FIG. 10 is a diagram illustrating example information stored in a storage of the IMS server according to the first example embodiment;

FIG. 11 is a diagram illustrating example IMS user data according to the first example embodiment;

FIG. 12 is a diagram illustrating example IMS authentication management data according to the first example embodiment;

FIG. 13 is a flowchart illustrating an example process by the personal computer, an example process by the EC server, and an example process by the terminal according to the first example embodiment;

FIG. 14 is a flowchart illustrating an example process by the EC server, an example process by the terminal, and an example process by the IMS server according to the first example embodiment;

FIG. 15 is a flowchart illustrating an example process by the personal computer, an example process by the EC server, and an example process by the terminal according to the first example embodiment;

FIG. 16 is a diagram illustrating an example display screen according to the first example embodiment;

FIG. 17 is a diagram illustrating an example display screen according to the first example embodiment;

FIG. 18 is a diagram illustrating an example display screen according to the first example embodiment;

FIG. 19 is a diagram illustrating an example display screen according to the first example embodiment;

FIG. 20 is a diagram illustrating an example display screen according to the first example embodiment;

FIG. 21 is a diagram illustrating an example display screen according to the first example embodiment;

FIG. 22 is a diagram illustrating an example display screen according to the first example embodiment;

FIG. 23 is a diagram illustrating an example display screen according to the first example embodiment;

FIG. 24 is a diagram illustrating an example display screen according to the first example embodiment;

FIG. 25 is a flowchart illustrating an example process by the EC server, an example process by the terminal, and an example process by the IMS server according to a first modified example;

FIG. 26 is a diagram illustrating an example payment management database according to the first modified example;

FIG. 27 is a diagram illustrating an example display screen according to a second example embodiment;

FIG. 28 is a diagram illustrating an example display screen according to the second example embodiment;

FIG. 29 is a diagram illustrating an example display screen according to the second example embodiment;

FIG. 30 is a diagram illustrating an example display screen according to the second example embodiment;

FIG. 31 is a diagram illustrating example user-by-user commodity category data according to a third example embodiment;

FIG. 32 is a diagram illustrating example commodity category collection data according to the third example embodiment;

FIG. 33 is a diagram illustrating an example friend management database according to a fourth example embodiment;

FIG. 34 is a diagram illustrating an example display screen according to the fourth example embodiment;

FIG. 35 is a diagram illustrating an example display screen according to the fourth example embodiment;

FIG. 36 is a diagram illustrating an example display screen according to a fourth modified example;

FIG. 37 is a diagram illustrating an example display screen according to a fifth example embodiment;

FIG. 38 is a diagram illustrating an example display screen according to the fifth example embodiment; and

FIG. 39 is a diagram illustrating example login statistical data according to the fifth example embodiment.

### DETAILED DESCRIPTION

[Compliance with Legal Requirements]

It should be noted that the disclosure by the present specification is premised on, to execute the present disclosure, compliance with legal requirements in terms of secrecy of communication, etc., in a country in which the present disclosure is to be implemented.

Example embodiments to carry out an information processing method, an information display method, a program, a terminal, and a server according to the present disclosure will be described with reference to the figures.

[System Configuration]

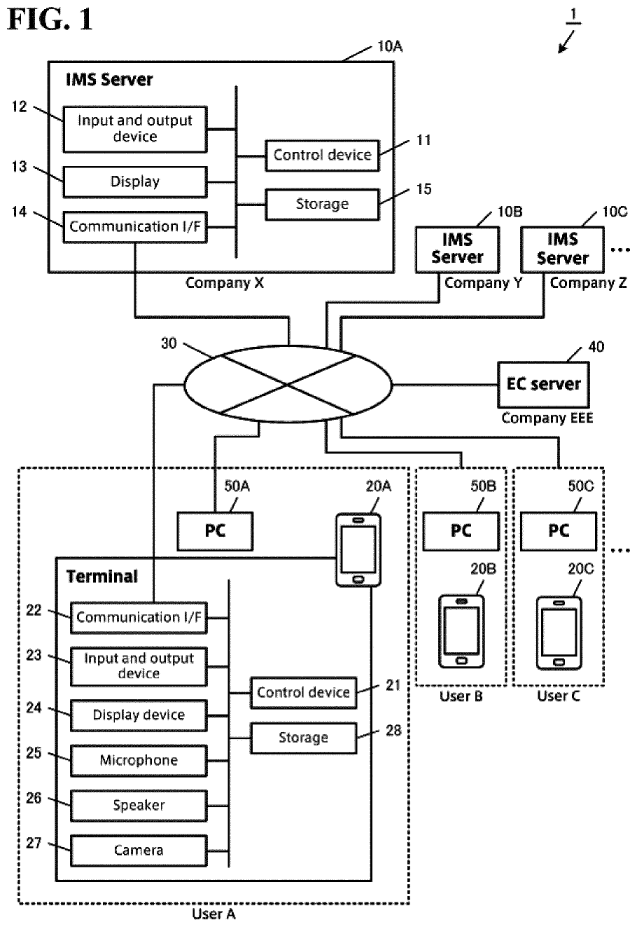

FIG. 1 illustrates a structure of a communication system 1 according to an example embodiment of the present disclosure. As disclosed in FIG. 1, connected in the communication system 1 through a network 30 are messaging service servers (each referred to as an Instant Messaging Service (IMS) server below) 10 (an IMS server 10A, an IMS server 10B, an IMS server 10C, and the like), terminals 20 (a terminal 20A, a terminal 20B, a terminal 20C, and the like), an Electronic Commerce server (referred to as an “EC server” below) 40, and Personal Computers (each referred to as a “PC” below) 50 (50A, 50B, 50C, and the like). The IMS server 10 provides a service that enables the terminal 20 owned by a user to transmit and receive messages among the terminals 20 via the network 30. Note that the number of the terminals 20 connected to the network 30 is not limited to any particular number.

The network 30 has a role of connecting the one or more terminals 20, the one or more IMS servers 10, the one or more EC servers 40, and the one or more PCs 50. That is, the network 30 is a communication network that establishes connection routes so as to enable data transmission and reception after the above-described various apparatuses are connected.

One or a plurality of portions of the network 30 may be a wired network, a wireless network, and the like. The network includes, not as limitations but as examples, an ad hoc network (ad hoc network), an intranet, an extranet, a Virtual Private Network (VPN), a Local Area Network (LAN), a Wireless LAN (Wireless LAN: WLAN), a Wide Area Network (WAN), a Wireless WAN (WWAN), a Metropolitan Area Network (MAN), a part of the Internet, a part of the Public Switched Telephone Network (PSTN), a mobile phone network, an Integrated Service Digital Network (ISDN), a wireless LAN, a Long Term Evolution (LTE), a Code Unit Multiple Access (CDMA), the Bluetooth (registered trademark), a satellite communication, etc., or a combination of equal to or greater than two of those. The network 30 may include the one or more networks 30.

The terminals 20 (the terminal 20A, the terminal 20B, the terminal 20C, and the like) (which are not as a limitation but as an example terminal or information processing device) are not limited to any particular terminals as long as those are information processing terminals that can accomplish the functions to be described in the respective embodiments. Each terminal 20 includes, not as limitations but as examples, a smart phone, a mobile phone (a feature phone), a computer (not as a limitation but as an example, a desktop computer, a laptop computer, or a tablet computer), a media computer platform (not as a limitation but as an example, a cable, a satellite set-top box, or a digital video recorder), a handheld computer device (not as a limitation but as an example, a Personal Digital Assistant (PDA), or an electronic mail client), a wearable terminal (such as a glasses-type device, or a clock type-device), other types of computers, or a communication platform. Moreover, the terminals 20 each may be referred to as an information processing terminal.

Since the basic structures of the terminal 20A, the terminal 20B, and the terminal 20C are common, the terminal 20 will be described in the following description. Moreover, in accordance with a necessity, the terminal utilized by a user X will be referred to as a terminal 20X, and user information in a predetermined service and in association with the user X or with the terminal 20X will be referred to as user information X. Note that the user information is information related to a user associated with an account that is utilized by the user in a predetermined service. The user information includes information associated with the user, such as, not as a limitation but as an example, a user's name, a user's icon image, a user's age, a user's gender, a user's address, a user's interest, and a user's identifier which are input by the user or are given by a predetermined service, and may be one of those pieces of information, or a combination thereof.

The IMS server 10 (not as a limitation but as an example second server) is provided with the function that provides a predetermined service that is the IMS to the terminal 20. The IMS server 10 is not limited to any particular device as long as it is an information processing device that can accomplish the functions described in the respective embodiments. The IMS server 10 is, not as limitations but as examples, a server device, a computer (not as a limitation but as an example, a desktop computer, a laptop computer, or a tablet computer), a media computer platform (not as a limitation but as an example, a cable, a satellite set-top box, or a digital video recorder), a handheld computer device (not as a limitation but as an example, a PDA or an electronic mail client), other types of computers, or a communication platform. Moreover, the IMS server 10 may be referred to as an information processing device. When it is not desired to distinguish the IMS server 10 from the terminal 20, the server 10 and the terminal 20 may be respectively referred to as information processing devices.

In the example embodiments to be described below, not as a limitation but as an example, a business operator that provides the IMS (not as a limitation but as an example service which manages the user information), in other words, the business operator of the IMS server 10 (not as a limitation but as an example business operator of the second server) is a company. Moreover, the name of the business operator of the IMS server 10A will be referred to as a “company X”, and the name of the IMS provided by the company X will be referred to as an “IMS-X”. Similarly, the name of the business operator of the IMS server 10B will be referred to as a “company Y”, and the name of the IMS provided by the company Y will be referred to as an “IMS-Y”. The name of the business operator of the IMS server 10C will be referred to as a “company Z”, and the name of the IMS provided by the company Z will be referred to as an “IMS-Z”.

The EC server 40 (not as a limitation but as an example first server) is provided with the function that provides an electronic commerce service (referred to as an “EC service” below) for providing and selling commodities, etc., (not as a limitation but as example information provided by the first server) over the electronic commerce website (referred to as an “EC site” below). The EC server 40 is not limited to any particular device as long as it is an information processing device that can accomplish the functions described in the respective embodiments. The EC server 40 is, not as limitations but as examples, a server device, a computer (not as a limitation but as an example, a desktop computer, a laptop computer, or a tablet computer), a media computer platform (not as a limitation but as an example, a cable, a satellite set-top box, or a digital video recorder), a handheld computer device (not as a limitation but as an example, a PDA or an electronic mail client), other types of computers, or a communication platform. Moreover, the EC server 40 may be referred to as an information processing device or an information management device.

In the example embodiments to be described below, not as limitations but as examples, the business operator that provides the EC service, in other words, the business operator of the EC server 40 (not as a limitation but as an example business operator of the first server) will be defines as a company. Next, the name of the business operator of the EC server 40 will be referred to as a “company EEE”, and the name of the EC site will be referred to as an “EC site EEE” as the same name as the name of the company.

The PC 50 (not as a limitation but as an example display apparatus) is a computer owned by the user of the terminal 20, and has a function to enable the user to purchase a commodity, etc., utilizing the EC service provided by the EC server 40 based on the login to the EC server 40. The PC 50 includes a computer, such as a desktop computer, a laptop computer, or a tablet computer.

In order to purchase (obtain) the commodity etc., that is sold (provided) through the EC server 40, it is desired to log in to the EC server 40. Since the wordings “to log in to the EC server 40” can be also referred to as “to log in to the EC site”, in the following description, it is assumed that those wordings have the same meaning.

In the following example embodiments, not as a limitation but as an example, each user has a set that includes the terminal 20 and the PC 50. It is assumed that, not as a limitation but as an example, the user A has the set that includes the terminal 20A and the PC 50A, the user B has the set that includes the terminal 20B and the PC 50B, and the user C has the set that includes the terminal 20C and the PC 50C.

[Hardware (HW) Configuration of Each Apparatus]

The HW configuration of each apparatus in the communication system 1 will be described.

(1) HW Configuration of Terminal

FIG. 1 illustrates an example HW configuration of the terminal 20.

The terminal 20 includes a control device 21 (a Central Processing Unit (CPU)), a storage 28, a communication I/F (interface) 22, an input and output device 23, a display device 24, a microphone 25, a speaker 26, and a camera 27. The respective HW components of the terminal 20 are, not as a limitation but as an example, connected with each other via a bus B. Note that it is not always desired to include all the components as the HW configuration of the terminal 20. Not as a limitation but as an example, the terminal 20 may employ a structure such that individual components, such as the microphone 25, and camera 27, or the plurality of components, are removable.

The communication I/F 22, under the control of the control device 21, transmits and receives various kinds of data via the network 30. The communication may be accomplished by either wired or wireless scheme, and any communication protocols are applicable as long as mutual communication is accomplished. The communication I/F 22 has a function of communicating with various apparatuses like the IMS server 10 via the network 30. The communication I/F 22 transmits various kinds of data to the various apparatuses like the IMS server 10 in accordance with the commands from the control device 21. Moreover, the communication I/F 22 receives various kinds of data transmitted from the various apparatuses like the IMS server 10, and transmits such data to the control device 21. Furthermore, the communication I/F 22 may be also simply referred to as a communicator. Still further, when the communication I/F 22 is formed by a physical circuit, it may be referred to as a communication circuit.

The input and output device 23 includes a device to input various operations to the terminal 20, and a device to output the process results processed by the terminal 20. The input and output device 23 may have the integrated input device and output device, or the separated input device and output device.

The input device is accomplished by any of all kinds of devices which receive a user's input, and which transmit information related to the input operation to the control device 21, or by a combination thereof. The input device is, not as limitations but as examples, hardware keys, such as a touch panel, a touch display, and a keyboard, a pointing device like a mouse, a camera (for an operation input through a video), and a microphone (for an operation input by voice).

The output device is accomplished by any of all kinds of devices that can output the process results processed by the control device 21, or by a combination thereof. The output device includes, not as limitations but as examples, a touch panel, a touch display, a speaker (for audio output), a lens (not as limitations but as examples, for three dimensions (3D) output and hologram output), and a printer, etc.

The display device 24 is accomplished by any of all kinds of devices capable of displaying in accordance with display data written in a frame buffer, or by a combination thereof. The displays 24 is, not as limitations but as examples, a touch panel, a touch display, a monitor (not as a limitation but as an example, a liquid crystal display or an Organic ElectroLuminescence Display (OELD)), a head mounted display (HDM), and a device capable of displaying an image or text information, etc., by projection mapping, hologram, and on air (which may be a vacuum), etc. Note that such a display device 24 may be able to display 3D display data.

When the input and output device 23 is a touch panel, the input and output device 23 and the display device 24 may be placed so as to face with each other at the substantially same size and shape.

The control device 21 includes a physical circuit structured so as to execute the function accomplished by a code or a command included in a program, and is accomplished by, not as a limitation but as an example, a data processing device built in hardware. Hence, the control device 21 may be referred to as a control circuit.

The control device 21 is, not as limitations but as examples, a Central Processing Unit (CPU), a micro-processor (a microprocessor), a processor-core (a processor core), a multi-processor (a multiprocessor), an Application-Specific Integrated Circuit (an ASIC), or a Field Programmable Gate Array (FPGA).

The storage 28 has a function of storing various programs and various pieces of data for the terminal 20 to operate. The storage 28 includes various kinds of storage media, such as a hard disk drive (an HDD), a solid-state drive (an SSD), a flash memory, a Random Access Memory (a RAM), and a Read-Only Memory (a ROM). Moreover, the storage 28 may be referred to as a memory.

The terminal 20 stores a program P in the storage 28, and executes the program P to cause the control device 21 to execute processes as each component in the control device 21. That is, the program P stored in the storage 28 causes the terminal 20 to accomplish the respective functions executed by the control device 21. Note that the program P may be referred to as a program module.

The microphone 25 is utilized for inputting voice data. The speaker 26 is utilized for outputting the voice data. The camera 27 is utilized for obtaining video image data.

(2) HW Configuration of IMS Server

FIG. 1 illustrates an example HW configuration of the IMS server 10.

The IMS server 10 includes a control device 11 (a CPU), a storage 15, a communication I/F (interface) 14, an input and output device 12, and a display 13. The respective HW components of the IMS server 10 are, not as a limitation but as an example, connected with each other via a bus B. Note that, regarding the HW of the IMS server 10, it is not always desired to include all the components as the HW configuration of the IMS server 10. Not as a limitation but an example, regarding the HW of the IMS server 10, a structure in which the display 13 is removable may be employed.

The control device 11 includes a physical circuit configured so as to execute the function accomplished by the code or command in the program, and is accomplished by, not as a limitation but as an example, a data processing device built in hardware.

The control device 11 is typically a Central Processing Unit (CPU), or may be a microprocessor, a processor core, a multiprocessor, an ASIC, or an FPGA. According to the present disclosure, the control device 11 is not limited to these examples.

The storage 15 has a function of storing various programs and various pieces of data for the IMS server 10 to operate. The storage 15 is accomplished by various kinds of storage media, such as an HDD, an SSD, or a flash memory. According to the present disclosure, however, the storage 15 is not limited to these examples. Moreover, the storage 15 may be referred to as a memory.

The communication I/F 14, under the control of the control device 11, transmits and receives various kinds of data via the network 30. The communication may be accomplished by either wired or wireless scheme, and any communication protocols are applicable as long as mutual communication is accomplished. The communication I/F 14 has a function of communicating with various apparatuses like the terminals 20 via the network 30. The communication I/F 14 transmits various kinds of data to the various apparatuses like the terminals 20 in accordance with the commands from the control device 11. Moreover, the communication I/F 14 receives various kinds of data transmitted from the various apparatuses like the terminals 20, and transmits such data to the control device 11. Furthermore, the communication I/F 14 may be also simply referred to as a communicator. Still further, when the communication I/F 14 is formed by a physical circuit, it may be referred to as a communication circuit.

The input and output device 12 is accomplished by a device to input the various operations to the IMS server 10. The input and output device 12 is accomplished by any of all kinds of devices capable of receiving the user's input, and of transmitting information related to the input operation to the control device 11, or by a combination thereof. The input and output device 12 is typically accomplished by a hardware key like a keyboard, and a pointing device like a mouse. Note that the input and output device 12 may include, not as limitations but as examples, a touch panel, a camera (for an operation input through a video), and a microphone (for an operation input by voice). According to the present disclosure, however, the input and output device 12 is not limited to these examples.

The display 13 is typically accomplished by a monitor (not as a limitation but as an example, a liquid crystal display or an Organic ElectroLuminescence Display (OELD)). Note that the display 13 may be a head mounted display (HDM), etc. Note that such a display 13 may display 3D display data. According to the present disclosure, the display 13 is not limited to these examples.

(3) HW Configuration of PC

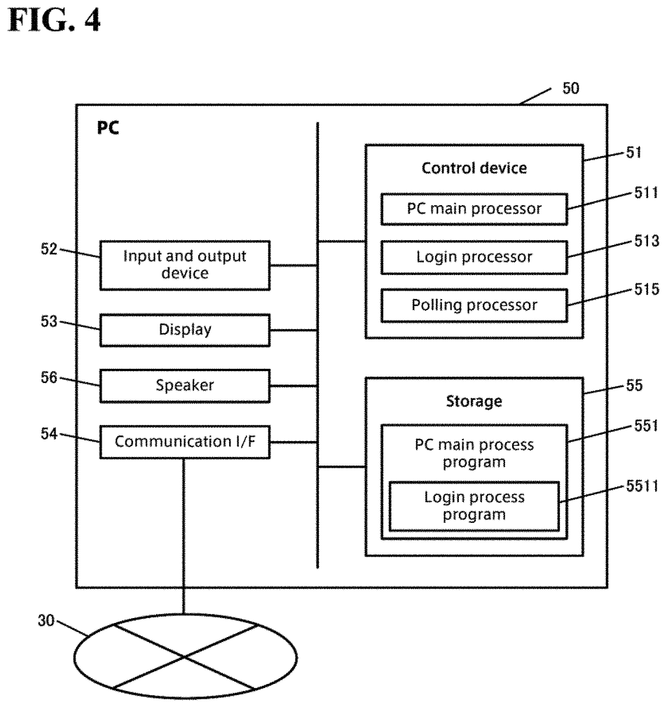

FIG. 4 illustrates an example HW configuration of the PC 50.

The PC 50 includes, not as limitations but as examples, a control device 51 (a CPU), a storage 55, a communication I/F 54 (an interface), an input and output device 52, a display 53, and a speaker 56. The respective HW components of the PC 50 are, not as a limitation but as an example, connected with each other via a bus B. Note that, regarding the HW of the PC 50, it is not always desired to include all the components as the HW configuration of the PC 50.

(4) HW Configuration of EC Server

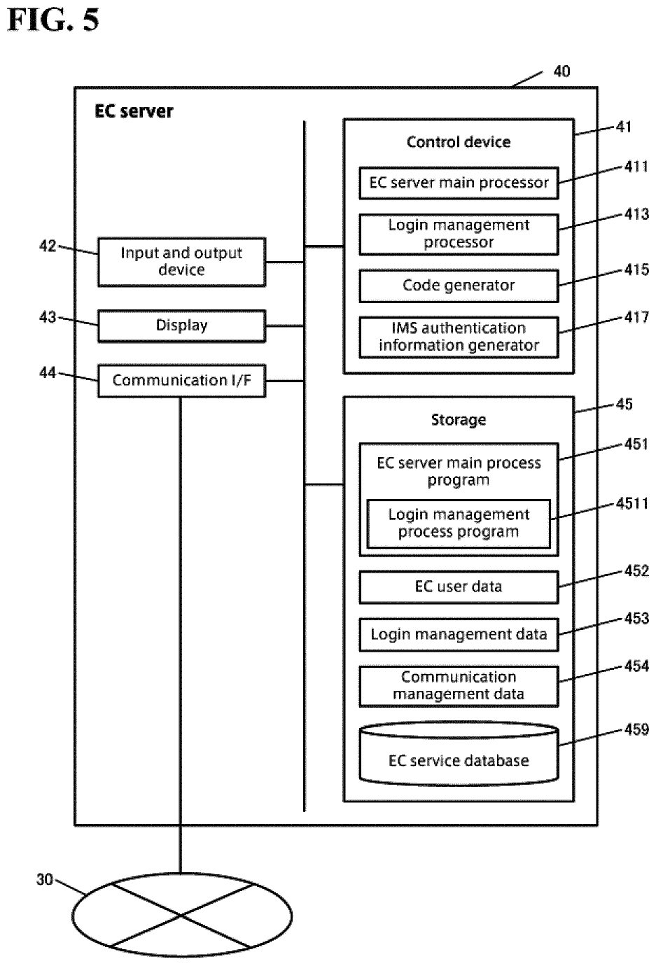

FIG. 5 illustrates an example HW configuration of the EC server 40.

The EC server 40 includes, not as limitations but as examples, a control device 41 (a CPU), a storage 45, a communication I/F 44 (an interface), an input and output device 42, and a display 43. The respective HW components of the EC server 40 are, not as a limitation but as an example, connected with each other via a bus B. Note that, regarding the HW of the EC server 40, it is not always desired to include all the components as the HW configuration of the EC server 40. Not as a limitation but an example, regarding the HW of the EC server 40, a structure in which the display 43 is removable may be employed. Moreover, the EC server 40 may include a speaker that is a sound output device which outputs sounds.

Note that the HW and the components, etc., to accomplish the above-described respective structural components and functional components included in the EC server 40 and in the PC 50 are similar to those of the IMS server 10. Hence, the description thereof will be omitted.

(5) Others

The IMS server 10 stores the program P in the storage 15, and executes this program P to cause the control device 11 to execute the respective processes as the components of the control device 11. That is, the program P stored in the storage causes the IMS server 10 to accomplish the respective functions to be executed by the control device 11. This program P may be referred to as a program module.

The same is true for the EC server 40 and the PC 50.

A description will be given of a case in which each example embodiment of the present disclosure is accomplished when the CPU of the terminal 20 and/or of the IMS server 10 executes the program P.

The same is true for the EC server 40 and the PC 50.

Note that the control device 21 of the terminal 20 and/or the control device 11 of the IMS server 10 may accomplish the respective processes by not only the CPU including a control circuit, but also a logical circuit (hardware) or a special-purpose circuit formed on an Integrated Circuit (IC) chip, or a Large Scale Integration (LSI), etc. Such circuits may be accomplished by one or a plurality of integrated circuits, and a plurality of processes to be described in the respective example embodiments may be accomplished by a single integrated circuit. Moreover, the LSI may be called as a VLSI, a super LSI, and an Ultra LSI, etc., depending on the difference in scale of integration. Hence, the control device 21 may be referred to as a control circuit.

The same is true for the EC server 40 and the PC 50.

Moreover, the program P (not as a limitation but as an example, a software program, a computer program, or a program module) according to each example embodiment of the present disclosure may be provided in a state stored in a computer readable storage medium. The program P can be stored in the storage medium that is a “non-transitory tangible medium”. Moreover, the program P may be for accomplishing some of the functions according to each example embodiment of the present disclosure. Furthermore, a so-called diff file (a diff program) may be applied which can accomplish the functions according to each example embodiment of the present disclosure in combination with the program P already stored in the storage medium.

The applicable storage media may be one or more semiconductor-based or other Integrated Circuits (not as a limitation but as an example, a Field Programmable Gate Array (FPGA) or an Application Specific Integrated Circuit (ASIC)), a Hard Disk Drive (HDD), a Hybrid Hard Drive (HHD), an optical disc, an Optical Disk Drive (ODD), a magneto-optical disc, a magneto-optical drive, a floppy diskette, a Floppy Disk Drive (FDD), a magnetic tape, a Solid-State Drive (SSD), a RAM drive, a secure digital card or drive, other arbitrary appropriate storage medium, or an appropriate combination of equal to or two of those examples. In an appropriate case, the storage medium may be volatile, non-volatile, or a combination of volatile and non-volatile forms. Note that the storage medium is not limited to these examples, and any devices or media are applicable as long as the program P can be stored. Moreover, the storage medium may be referred to as a memory.

The IMS server 10 and/or the terminal 20 reads the program P stored in the storage medium, and executes the program P to accomplish the functions of a plurality of functional components described in each example embodiment.

The same is true for the EC server 40 and the PC 50.

Moreover, the program P according to the present disclosure may be provided to the IMS server 10 and/or the terminal 20 via an arbitrary transmission medium (a communication network or broadcast waves, etc.,) that can transmit a program. The IMS server 10 and/or the terminal 20 executes the program P downloaded via, not as a limitation but as an example, the Internet to accomplish the functions of the plurality of functional components described in each example embodiment.

The same is true for the EC server 40 and the PC 50.

Moreover, according to each example embodiment of the present disclosure, the program P may be accomplished by electric transmission, such as in the form of data signals superimposed on carrier waves.

At least some of the processes by the IMS server 10 and/or the terminal 20 may be accomplished by cloud computing established by a plurality of computers.

At least some of the processes by the terminal 20 may be executed by the IMS server 10. In this case, at least some of the processes by the respective functional components of the control device 21 of the terminal 20 may be executed by the IMS server 10.

At least some of the processes by the IMS server 10 may be executed by the terminal 20. In this case, at least some of the processes by the respective functional components of the control device 11 of the IMS server 10 may be executed by the terminal 20.

The structure on a determination in the example embodiment of the present disclosure is not essential as far as there is an apparent notation, a desired (or alternatively, predetermined) process may be executed when a determination condition is satisfied, or the desired (or alternatively, predetermined) process may be executed when the determination condition is not satisfied.

Note that the program according to the present disclosure is implemented using, not as a limitation but as an example, a script language, such as ActionScript or JavaScript (registered trademark), an object-orientation programming language, such as Objective-C or Java (registered trademark), or a markup language like HTML5, etc.

Moreover, although it is a repeated description, the various programs and the various data according to the present disclosure can be stored (recorded) in a computer readable storage medium (recording medium). Various kinds of storage media, such as a magnetic disk, an optical disc, a magneto-optical disc, and a flash memory, are applicable as such a storage medium.

### First Example Embodiment

Recently, network services, such as the Instant Messaging Service (IMS) and the Social Networking Service (SNS), are prevalent.

The “IMS” is a service that executes message transmission and reception among the communication apparatuses of users in order to have a conversation among the users of the communication apparatuses using the Internet, and the IMS server 10 is a server that provides this IMS. In this specification, although the term “IMS” which is the abbreviated name for the Instant Messaging Service is used, such a term includes entire messaging services in a broad sense, and is not limited to the Instant Messaging Service.

The “SNS” is a service to form a social network or community over the Internet for the purpose of mainly carrying out communications among the users of the communication apparatuses. Note that the IMS can be considered as a form (one form) of the SNS. Hence, the IMS and the SNS may be distinguished from each other.

Moreover, systems are now being operated in which the user who utilizes the above-described service utilizes user information (not as a limitation but as example user personal information or user account) registered to utilize the above-described service, and receives the different service from the above-described service. An example different service is, not as a limitation but as an example, the above-described Electronic Commerce (EC).

According to a first example embodiment, not as a limitation but as an example, the service that manages the user information is the “IMS”, and the login to the EC server is accomplished using not the code prepared for each business operator of the IMS server 10 but a code (referred to as a “common code” below) common to the business operators of the respective IMS servers 10 as a code to log in to the EC server or to the EC site.

For example, the EC server 40 generates a login code which is a code utilized to log in to the EC server 40 (the EC site) and which is also the common code, and transmits the generated code to the PC 50. The login code displayed on the PC 50 is read by the code reader of the terminal 20, and information related to the read login code is transmitted to the EC server 40 from the terminal 20. Next, after the user of the terminal 20 is authenticated by the IMS server 10 of the IMS identified based on the information which is related to the code reader and transmitted from the terminal 20, user information stored and registered in this IMS server 10 is obtained by the EC server 40 from this IMS server 10, and the log-in to the EC server 40 (the EC site) from the PC 50 is executed based on the obtained user information.

The details described in the first example embodiment is applicable to any of the other example embodiments.

[Functional Structure]

### (1) Functional Structure of Terminal

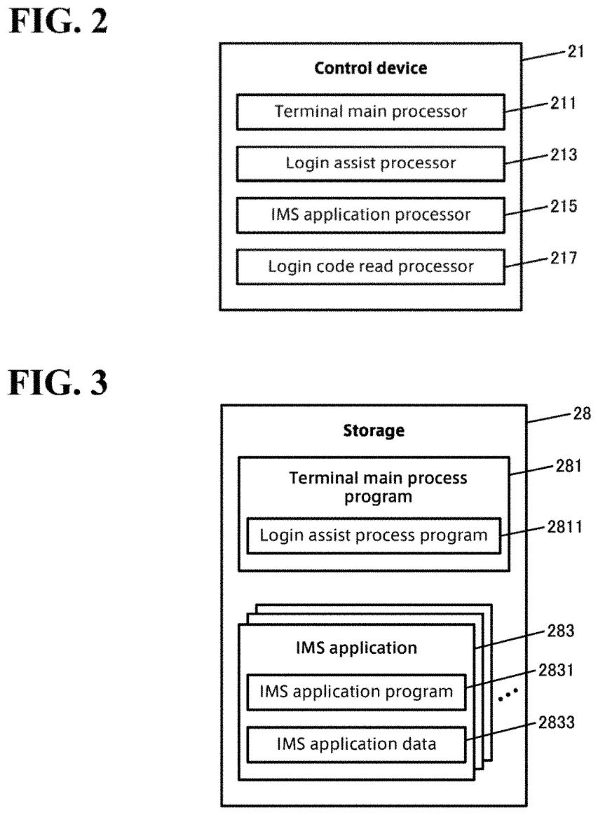

FIG. 2 is a diagram illustrating example functions accomplished by the control device 21 of the terminal 20 according to this example embodiment.

The terminal 20 includes a terminal main processor 211, a login assist processor 213, an IMS application processor 215, and a login code read processor 217 as functions accomplished by the control device 21.

The terminal main processor 211 has a function to execute a terminal main process that is a process to comprehensively control the terminal 20 in accordance with a terminal main process program 281 stored in the storage 28. Not as limitation but as an example, when the terminal 20 is a mobile phone, a control to make a call to the other mobile phone or to a fixed-line telephone by the communication I/F 22, a control to access various kinds of websites by the communication I/F 22, a control to cause the display device 24 to display various information, a process of analyzing various kinds of sound data input from the microphone 25, a process to analyze still images or videos picked up by the camera 27, etc., are executed.

The login assist processor 213 has a function to execute a login assist process that is a process to assist the PC 50 of the user of the terminal 20 to log in to the EC server 40 (the EC site) in accordance with a login assist program 2811 stored in the storage 28.

The IMS application processor 215 has a function to execute an IMS application process that is a process to transmit and receive information related to the IMS (not as a limitation but as examples, a message, an image, contents, etc.) with the other terminal 20 via the IMS server 10 based on an IMS application program 2831 included in an IMS application 283 downloaded from the IMS server 10 and stored in the storage 28 in advance, and also on an IMS application data 2833 also included therein.

The login code read processor 217 has a function to execute processes of activating an IMS application code reader (not as a limitation but as an example code reader), which is a code reader activated in the IMS application executed by the IMS application processor 215, and processes of causing the activated code reader to read the login code displayed on the display 53 of PC 50.

FIG. 3 is a diagram illustrating example information stored in the storage 28 of the terminal 20 according to this example embodiment.

The storage 28 stores, not as a limitation but as an example, the terminal main process program 281 which is read by the control device 21, and which is executed as a terminal main process.

Moreover, the terminal main process program 281 includes a subroutine program that is the login assist program 2811 which is read by the control device 21, and which is executed as a login assist process. The login assist process will be described in detail below with reference to flowcharts.

Furthermore, the storage 28 stores, not as a limitation but as an example, the plurality of IMS applications 283 downloaded from the respective IMS servers 10 (10A, 10B, and 10C, etc.) of the respective business operators (the respective companies).

Each IMS application 283 includes the IMS application program 2831 which is read by the control device 21, and which is executed as the IMS application process, and the IMS application data 2833 in which various kinds of data related to the IMS application are stored.

(2) Functional Structure of PC

FIG. 4 illustrates example functions accomplished by the control device 51 of the PC 50 according to this example embodiment.

The PC 50 includes, as functions accomplished by the control device 51, which includes a PC main processor 511, a login processor 513, and a polling processor 515.

The PC main processor 511 has a function to execute a PC main process that is a process of comprehensively controlling the PC 50 in accordance with the PC main process program 551 stored in the storage 55.

The login processor 513 has a function to execute a login process that is a process of logging in to the EC server (the EC site) in accordance with the login process program 5511 stored in the storage 55.

The polling processor 515 has a function to execute a polling process that is a process of polling to the EC server 40. The polling process will be described with reference to the flows of the login process.

FIG. 4 illustrates example information stored in the storage 55 of the PC 50 according to this example embodiment.

The storage 55 stores, not as a limitation but as an example, a PC main process program 551 which is read by the control device 51, and which is executed as the PC main process.

Moreover, the PC main process program 551 includes a subroutine program that is the login process program 5511 which is read by the control device 51, and which is executed as the login process. The login process will be described below with reference to the flowcharts.

(3) Functional Structure of EC Server

FIG. 5 illustrates example functions accomplished by the control device 41 of the EC server 40 according to this example embodiment.

The EC server 40 includes, as functions accomplished by the control device 41, an EC server main processor 411, a login management processor 413, a code generator 415, and an IMS authentication information generator 417.

The EC server main processor 411 has a function to execute an EC server main process that is a process of comprehensively controlling the EC server 40 in accordance with the EC server main process program 451 stored in the storage 45.

The login management processor 413 has a function to execute a login management process that is a process of managing a login to the EC site provided by the EC server 40 over the Internet from the PC 50 according to this example embodiment.

The code generator 415 has a function to generate the login code (referred to as the “login code” below) to execute an authentication (not as a limitation but as an example user authentication) to log in to the EC server 40 (the EC site) from the PC 50 which enables the user of the terminal 20 to purchase a commodity, etc. to be sold over the EC site by the EC server 40 using the PC 50.

According to this example embodiment, the code generator 415 generates the login code that is, not as a limitation but as an example, a two-dimensional code. The two-dimensional code is a code in a display scheme which has pieces of information in the horizontal direction and in the vertical direction. Examples are a matrix-type code (referred to as a “matrix code” below) which has small squares arranged in the vertical and horizontal directions, a stack-type code (referred to as a “stack code” below) which has a plurality of one-dimensional codes (e.g., bar codes) laid over on each other, etc.

In the following example embodiments, for the purpose of facilitating understanding, a QR code (registered trademark) that is an example matrix code utilized widely will be described as an example login code.

Note that unlike the following example embodiments, as for the matrix codes other than the QR code, an SP code, a VeriCode, a maxi code, a CP code, and a chameleon code, etc., may be utilized as the login code. Moreover, instead of the matrix code, various kinds of stack codes may be utilized as the login code.

The code generator 415 generates, based on a login request that is received from the PC 50, the login code that is the QR code which includes access information to access the EC site, association information which is information to associate the terminal 20 with the EC server 40 (or the user of the terminal 20 with the EC server 40), and transmission request information of requesting a transmission of the information related to the code reader that reads the two-dimensional code to the EC server 40.

In this example, the term “code reader” is a code reader to read a two-dimensional code, and in this example embodiment, is the IMS application code reader (a QR code reader in this example embodiment) to read the two-dimensional code (the QR code in this example embodiment) and activated in the IMS application executed by the terminal 20.

The access information includes, not as a limitation but as an example, a Uniform Resource Locator (URL) that indicates the address (a webpage address) of the EC site over the Internet.

The association information includes, not as a limitation but as an example, a token which is desired to log in to the EC server 40 (the EC site), and which is issued by the EC server 40 at random (referred to as a “login token” below).

The token is a kind of the authentication information that is issued by a certificate authority, and the login token in this example embodiment is authentication information issued by the EC server 40 as the certificate authority to authenticate the terminal 20 or the user of the terminal 20. The login token can be also referred to as a “random token” or an “access token”. Since the login token is issued at random, every time the login code is displayed on the PC 50, a different token is generated.

The transmission request information includes, not as a limitation but as an example, a transmission command that is a command to request a transmission of the information related to the code reader which reads the two-dimensional code (in this example embodiment, the login code) to the EC server 40. In this example, the information related to the code reader includes, not as limitations but as examples, information to identify the code reader which reads the login code, and information to identify the IMS in which the code reader that reads the login code is activated.

Note that when the terminal 20 is programmed so as to transmit the information related to the code reader which reads the two-dimensional code, the above-described transmission request information (the transmission command, etc.) may not need to be transmitted to the terminal 20. Hence, it is not always desired that the transmission request information is included in the login code, and the login code may include no transmission request information.

The IMS authentication information generator 417 has a function to generate IMS authentication information (not as a limitation but as example information related to a service which manages the user information) that is information desired for the user of the terminal 20 to receive the IMS authentication by the IMS server 10 to be described later.

FIG. 5 illustrates example information stored in the storage 45 of the EC server 40 according to this example embodiment.

The storage 45 stores, not as a limitation but as an example, the EC server main process program 451 which is read by the control device 41 and which is executed as the EC server main process.

Moreover, the EC server main process program 451 includes a subroutine program that is the login management process program 4511 which is read by the control device 41, and which is executed as the login management process. The login management process will be described in detail below with reference to flowcharts.

Furthermore, the storage 45 stores, not as limitations but as examples, EC user data 452, login management data 453, communication management data 454, and an EC service database 459.

The EC server 40 stores in advance “EC user information” that is the personal information related to the user of the terminal 20 transmitted from the PC 50, etc., in order to allow the user to utilize the EC service.

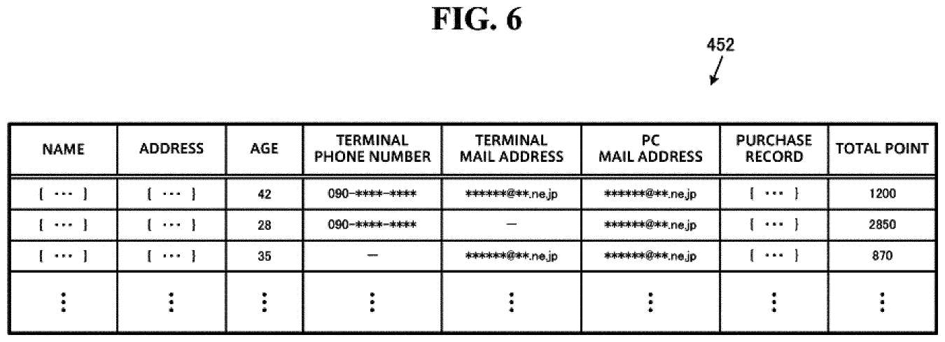

The data in which this EC user information is stored is the EC user data 452, and FIG. 6 illustrates an example data structure thereof.

Stored in the EC user data 452 are, not as limitations but as examples, a user's name, a user's address, a user's age, the telephone number (referred to as a “terminal phone number” below) of the terminal 20 of the user, the mail address (referred to as a “terminal mail address” below) of the terminal 20 of the user, the mail address (referred to as a “PC mail address” below) of the PC 50 of the user, a purchase record of commodities, etc., at the EC site by the user, and the total point that is privilege information given to the user in accordance with the purchase of the commodity, etc., at the EC site, in association with each other. Note that at least any one of the above-described information may be stored in the EC user data 452, or the combination of the above-described information may be stored therein.

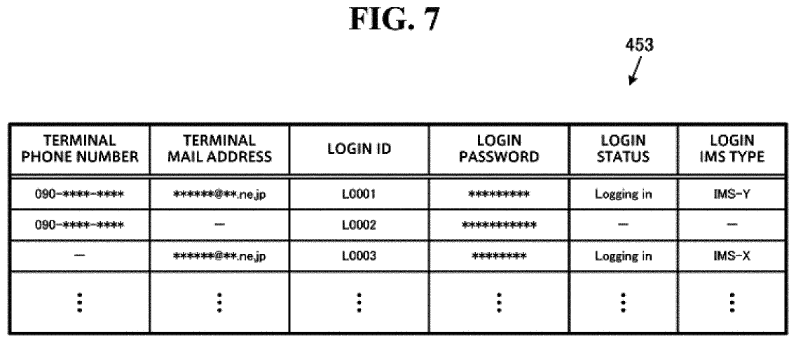

The login management data 453 is data to manage the login to the EC server 40 (the EC site), and FIG. 7 illustrates an example data structure thereof.

Stored in the login management data 453 are, not as limitations but as examples, the terminal phone number, the terminal mail address, a login ID, a login password, a login status, and a login IMS kind, in association with each other.

The terminal phone number stores the terminal phone number that is stored in the EC user data 452.

The terminal mail address stores the terminal mail address that is stored in the EC user data 452.

The login ID stores a login ID desired to log in to the EC server 40 (the EC site).

The login password stores a login password desired to log in to the EC server 40 (the EC site).

The login ID and the login password are the ID as the login account of the user registered by the EC server 40 in order to allow the user to utilize the EC, and the password associated with this account, respectively. Such login ID and login password may be automatically generated by the EC server 40 and stored and registered in the login management data 453 at the time of initial registration. In some example embodiments, the login ID and the login password arbitrary decided and input by the user at the time of initial registration may be stored and registered in the login management data 453. Moreover, these login ID and login password may be generated again or set again after the registration.

The login status is information indicating whether or not the user is logging in the EC server 40 (the EC site). When the user is logging in, “logging in” is stored, and when the user is not logging in, “-(indicating not logging in)” is stored.

The login IMS kind (or type) is user information (referred to as “IMS user information” below) of the user of the terminal 20 stored by the IMS server 10, and is the kind of the IMS of the IMS server 10 which is the transmission originator of the IMS user information when the EC server 40 receives the IMS user information from the IMS server 10 in order to execute the login authentication. Not as limitations but as examples, the name of the IMS, and the ID of the company that provides the IMS, etc., are stored. An example case in which the IMS names, such as “IMS-Y” and “IMS-X”, are stored is illustrated in the figure.

According to this example embodiment, a description will be given of an example in which both the terminal phone number and the terminal mail address are stored in the EC user data 452 and in the login management data 453 for all users in some cases, but either the terminal phone number or the terminal mail address may not be stored depending on the user. This is because, according to the scheme of this example embodiment, it is not always desired to store both the terminal phone number and the terminal mail address in order to accomplish a login to the EC site, and either information is sufficient for such an accomplishment. Moreover, some users do not want to register both the terminal phone number and the terminal mail address when registering the personal information.

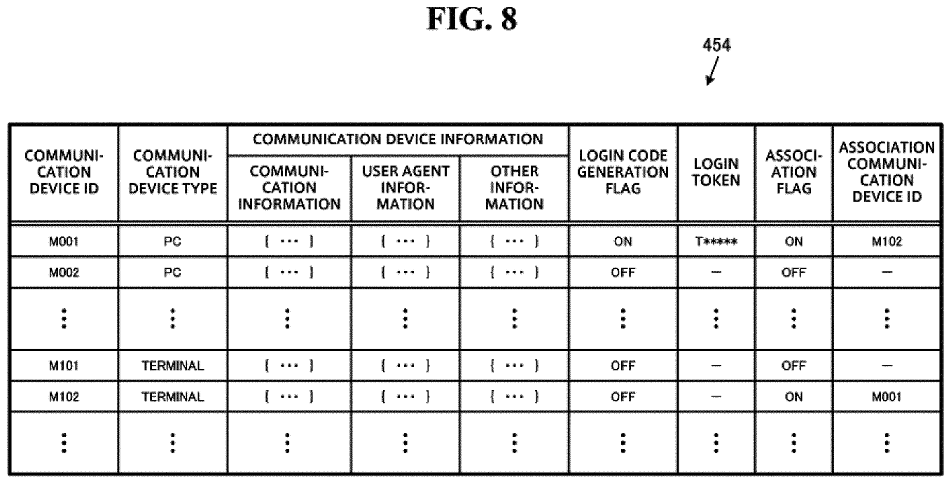

The communication management data 454 is data to manage information related to a communication with the communication apparatus (e.g., the PC 50 and the terminal 20) that accesses the EC site, and FIG. 8 illustrates an example data structure.

Stored in the communication management data 454 are, not as limitations but as examples, a communication apparatus ID, a communication apparatus kind, communication apparatus information, a login code generation flag, the login token, an association flag, and an association communication apparatus ID, in association with each other.

The communication apparatus ID stores an ID that is the identification information to identify the communication apparatus which accesses the EC site.

The communication apparatus kind (or type) stores the kind of the communication apparatus that accesses the EC site. Not as a limitation but as an example, when the kind of the communication apparatus is the PC 50, “PC” is stored, and when the kind of the communication apparatus is the terminal 20, “terminal” is stored.

The communication apparatus information stores information related to the communication apparatus transmitted from the communication apparatus that accesses the EC site. The communication apparatus information includes, not as limitations but as examples, communication information, user agent information, and other information.

The communication information stores, as desired information to communicate with the communication apparatus that accesses the EC site, information, such as the IP address of the communication apparatus, the host name of the communication apparatus, the communication port of the communication apparatus, and the URL of a page requested by the communication apparatus to be displayed.

The user agent information stores information, such as the kind of the Operating System (OS) utilized by the communication apparatus, the kind of a browser, and the kind of the utilized communication apparatus (PC, terminal, etc.). The above-described communication apparatus kind is identified based on this user agent information.

The other information includes information, such as pieces of information related to the language of the browser of the communication apparatus, the character code of the browser, the connection scheme of the browser, and the URL of a transition originator page, input information to the page, information related to a monitor of the communication apparatus, position information related to the communication apparatus, and plug-in information.

The above-described communication apparatus information is information transmitted (notified) to the EC server 40 from the communication apparatus when the communication apparatus accesses the EC site. The control device 41 stores the communication apparatus information received from the communication apparatus in the communication management data 454 in association with the communication apparatus ID. Note that the communication apparatus information does not include information (personal information) that can identify the individual user.

The login code generation flag is a flag indicating whether or not the login code is generated for the communication apparatus with the communication apparatus ID. When the login code is generated, “ON” is stored, and when the login code is not generated, “OFF” is stored.

According to this example embodiment, a description will be given of an example in which the login code is generated for only the PC 50 (e.g., the communication apparatus with the communication apparatus kind that is “PC”). Hence, regarding the communication apparatus with the communication apparatus kind that is “PC”, the login code generation flag is set to be “ON” when the login code is generated, but regarding the communication apparatus with the communication apparatus kind that is “terminal”, the login code generation flag remains unchanged as “OFF”.

The login token stores the login token included in the login code generated for the communication apparatus which has the login code generation flag set to be “ON”. The login token is illustrated as “T*****” in the figure.

The association flag is a flag indicating whether or not the communication apparatus with the communication apparatus kind that is “PC” and the communication apparatus with the communication apparatus kind that is “terminal” are associated with each other, and is set as “ON” when associated, and is set as “OFF” when not associated.

The association communication apparatus ID is the ID of the associated communication apparatus. The communication apparatus ID of the communication apparatus with the communication apparatus kind that is “terminal” is stored and associated with the communication apparatus with the communication apparatus kind that is “PC”, and the communication apparatus ID of the communication apparatus with the communication apparatus kind that is “PC” is stored and associated with the communication apparatus with the communication apparatus kind that is “terminal”.

According to this example embodiment, when a login request is received from the PC 50, the code generator 415 generates the above-described login code. Next, the login code page that includes the image of the generated login code is transmitted to the PC 50 that is a communication counterpart based on the communication apparatus information received from the PC 50. This causes the login code page to be displayed on the display of the PC 50 that is the communication counterpart.

The login code displayed on the display 53 of the PC 50 is read by the code reader of the terminal 20 of the user, and the information included in the login code is identified.

The login token included in the login code is the random and unique token that is issued by the EC server 40. Hence, when the terminal 20 subsequently accesses the EC site, transmission of the identified login token to the EC server 40 enables the EC server 40 to associate (relate) the terminal 20 with the PC 50.

For example, when the terminal 20 communicates with the EC server 40 and the login token is transmitted to the EC server 40 from the terminal 20, the EC server 40 searches and identifies, among the login tokens stored in the communication management data 454, the login token that matches the login token received from the terminal 20. This enables the EC server 40 to determine that the login code displayed on the PC 50 with the communication apparatus ID stored in the communication management data 454 in association with the identified login token is read by the terminal 20 that is the communication counterpart, enabling an association between the terminal 20 that is the communication counterpart and the PC 50.

The EC service database 459 is a database that stores data related to the EC service provided by the EC servers 40, such as image data of the EC site, data related to the category (the classification) of the commodity sold on the EC site, image data of the commodity, and price data related to the commodity.

(4) Functional Structure of IMS Server

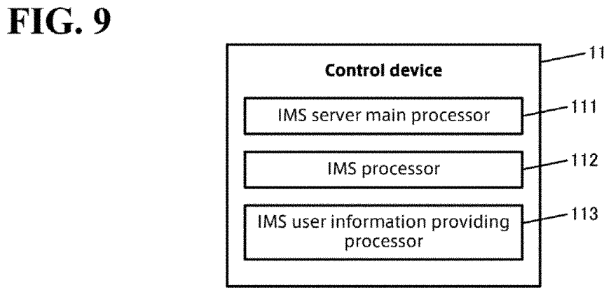

FIG. 9 is a diagram illustrating example functions accomplished by the control device 11 of the IMS server 10 according to this example embodiment.

The IMS server 10 includes, as functions accomplished by the control device 11, an IMS server main processor 111, an IMS processor 112, and an IMS user information providing processor 113.

The IMS server main processor 111 has a function to execute an IMS server main process that is a process of comprehensively controlling the IMS server 10 in accordance with the IMS server main process program 151 stored in the storage 15.

The IMS processor 112 has a function to execute an IMS process that is a process of transmitting and receiving information related to the IMS (not as limitations but as examples, a message, an image, and contents, etc.) among the plurality of terminals 20 in accordance with the IMS process program 1511 stored in the storage 15. Note as a limitation but as an example, the IMS processor 112 transmits (transfers), when receiving a message transmitted from the terminal 20 in a predetermined talkroom, etc., such a message to the terminal 20 of the other participating user as a destination.

The IMS user information providing processor 113 has a function to execute an IMS user information providing process that is a process of providing, to the EC server 40 via the network 30, the IMS user information stored and managed by IMS user data 152 in the storage 15 in accordance with the IMS user information providing process program 1513 stored in the storage 15.

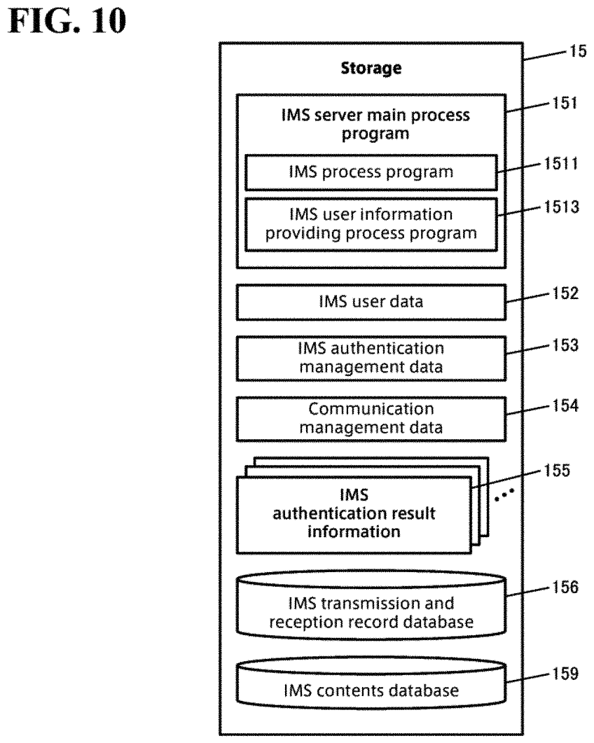

FIG. 10 is a diagram illustrating example information stored in the storage 15 of the IMS server 10 according to this example embodiment.

The storage 15 stores, not as limitations but as examples, the program that is the IMS server main process program 151 which is read by the control device 11 and which is executed as the IMS server main process.

Moreover, the IMS server main process program 151 includes subroutine programs that are the IMS process program 1511 which is read by the control device 11 and which is executed as the IMS process, and the IMS user information providing process program 1513 which is read by the control device 11 and which is executed as the IMS user information providing process. The IMS user information providing process will be described below in detail with reference to flowcharts.

Moreover, the storage 15 stores, not as limitations but as examples, pieces of data that are the IMS user data 152, IMS authentication management data 153, communication management data 154, IMS authentication result information 155, an IMS transmission and reception record database 156, and an IMS contents database 159.

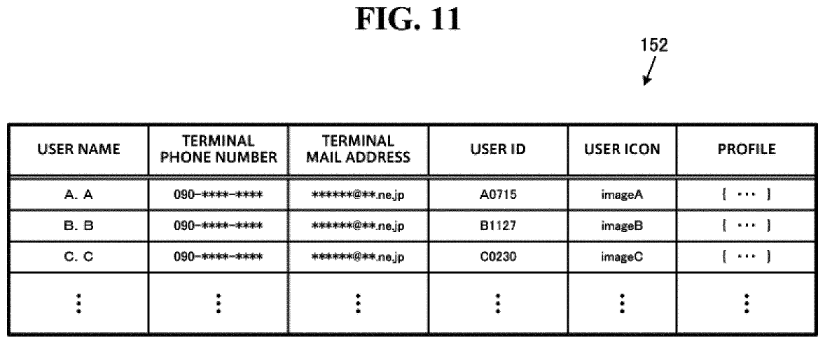

The IMS user data 152 is data to manage the IMS user information, and FIG. 11 illustrates an example the data structure thereof.

Stored in the IMS user data 152 are, not as limitations but as examples, the user name, the terminal phone number, the terminal mail address, the user ID, the user icon, and the profile in association with each other.

The user name is an IMS user name, and the name registered when the user of the terminal 20 utilizes the IMS service is stored.

The terminal phone number is the phone number of the terminal 20 of the user with such a user name, and the phone number of the terminal 20 registered when the user of the terminal 20 utilizes the IMS service is stored.

The terminal mail address is the mail address of the terminal 20 of the user with such a user name, and the mail address of the terminal 20 registered when the user of the terminal 20 utilizes the IMS service is stored.

The user ID is the ID that functions as identification information to identify the user with such a user name, and an ID to uniquely identify each user is stored.

The user icon is the image data of the icon which is set at the terminal 20 of the user with such a user name, is transmitted to the IMS server 10, and is utilized by the user. In the IMS application, the image of this icon is displayed in association with the user name.

The profile is the profile of the user which is set at the terminal 20 of the user with such a user name, and which is transmitted to the IMS server 10. In the IMS application, this profile is displayed in association with the user name.

Note that although the description will be given of a case in which each user utilizes the IMS by the own terminal 20 in this example embodiment, each user may utilize the IMS by the own PC 50 in addition to the terminal 20 or instead of the terminal 20.

The IMS authentication management data 153 is data to manage information for the IMS authentication. In this example embodiment, the authentication by the IMS server 10 such that the user of the terminal 20 is the IMS legitimate user will be referred to as the “IMS authentication”. Moreover, a description will be given of a case in which, when the IMS authentication results becomes OK, the IMS server 10 is enabled to provide the IMS user information to the EC server 40.

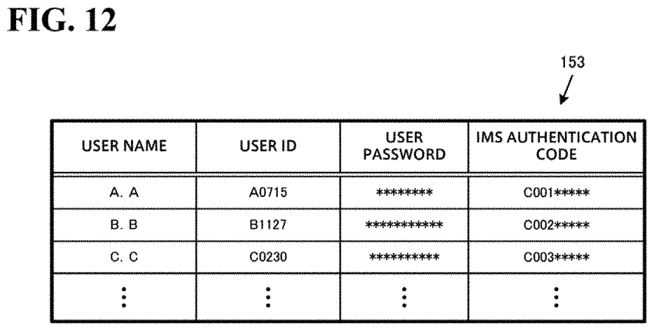

FIG. 12 is a diagram illustrating an example data structure of the IMS authentication management data 153.

Stored in the IMS authentication management data 153 are, not as limitations but as examples, the user name, the user ID, the user password, and an IMS authentication code in association with each other.

Stored in the user name is the user name of each user stored in the IMS user data 152.

Stored in the user ID is the user ID of each user stored in the IMS user data 152. This user ID is utilized to identify each user, and also utilized to execute the IMS authentication.

The user password is a password which is set at the terminal 20 of the user with such a user ID, and is transmitted to the IMS server 10. This user password is utilized together with the user ID to execute the IMS authentication.

The IMS authentication code (not as a limitation but as example information indicating that the user of the terminal is authenticated by the service) is a code indicating that the IMS authentication result for the user with such a user ID is OK. In the figure, the IMS authentication code is indicated as “C001*****”.

The communication management data 154 is data to manage information related to a communication with the communication apparatus (e.g., the terminal 20 and the EC server 40) that accesses the IMS site. Stored in this communication management data 154 is communication apparatus information transmitted from the communication apparatus in association with the communication apparatus ID or a communication apparatus kind.

The IMS authentication result information 155 is information which is generated for each user of the terminal 20 having the IMS authentication result that is OK, and which is utilized to notify the terminal 20 of the IMS authentication result. Stored in this IMS authentication result information 155 are, not as limitations but as examples, the EC site URL and the IMS authentication code.

The IMS transmission and reception record database 156 is a database that stores record information related to transmission and reception of the message, etc., transmitted and received between the terminals 20 of the users who utilize the IMS.

The IMS contents database 159 is a database that stores data related to various contents related to the IMS.

[Processes]

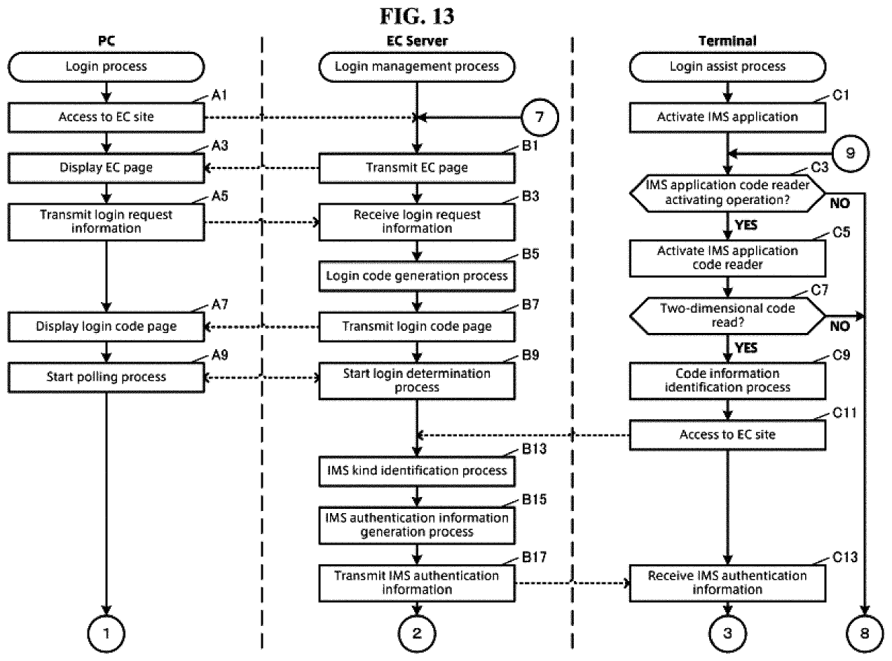

FIG. 13 to FIG. 15 are flowcharts illustrating example process flows executed by the respective apparatuses according to this example embodiment.

FIG. 13 illustrates, from the left side in sequence, a login process that is executed by the login processor 513 of the PC 50, a login management process that is executed by the login management processor 413 of the EC server 40, and a login assist process that is executed by the login assist processor 213 of the terminal 20, respectively.

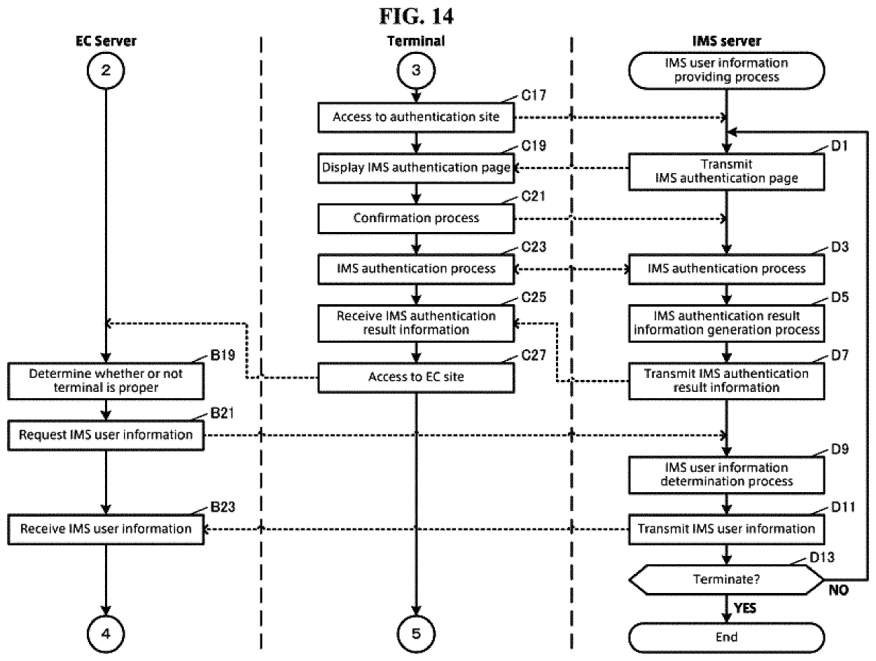

Moreover, FIG. 14 illustrates, from the left side in sequence, the login management process continuous from that in FIG. 13, the login assist process continuous from that in FIG. 13, and an IMS user information providing process that is executed by the IMS user information providing processor 113 of the IMS server 10, respectively.

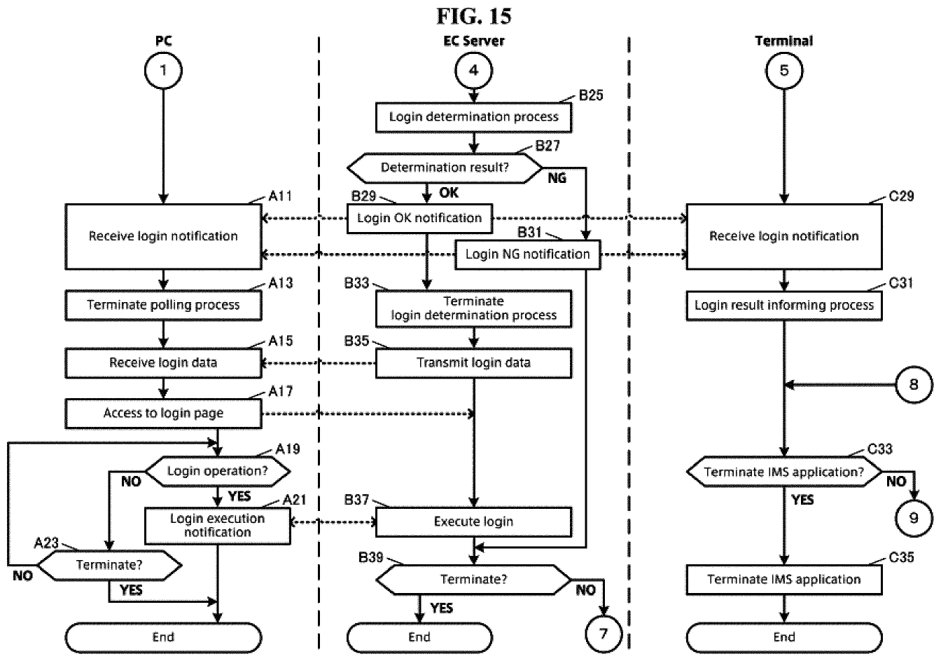

Furthermore, FIG. 15 illustrates, from the left side in sequence, the login processing continuous from that in FIG. 13, the login management process continuous from that in FIG. 14, and the login assist process continuous from that in FIG. 14, respectively.

Still further, each operation in each process will be denoted by a combination of a capitalized alphabet with a number, and in this specification, some operations may be omitted.

Note that the flowcharts to be described below merely illustrate the processes according to this example embodiment, execution of some operations may be omitted or an additional operation may be inserted in the flowchart to be described below.

First, in accordance with the access operation to the EC site given to the input and output device 52, the login processor 513 accesses the EC site by the communication I/F 54, and transmits, to the EC server 40, the communication apparatus information related to the own apparatus by the communication I/F 54 (A1).

The login management processor 413 determines the communication apparatus kind based on the user agent information included in the communication apparatus information received from the PC 50 by the communication I/F 44, and stores the communication management data 454 in the storage 45, the communication apparatus ID and the communication apparatus kind in association with each other. Next, the login management processor 413 transmits, to the PC 50 by the communication I/F 44, the EC page (electronic commerce page) of the EC site based on the communication apparatus information stored in the communication management data 454 (B1). Hence, the EC page is displayed on the display 53 of the PC 50 (A3).

Subsequently, the login processor 513 transmits, to the EC server 40 by the communication I/F 54, the login request information to the EC server 40 (the EC site) in accordance with the user's login operation given to the input and output device (A5).

In this example, the timing at which the login request information is transmitted may be the timing at which the user's login operation at the top page of the EC site is detected, and the timing at which a transition from the top page is made and the user's login operation at the shop page that displays the commodities, etc., is detected.

When the login request information is received from the PC 50 by the communication I/F 44 (B3), the code generator 415 of the EC server 40 executes the login code generation process (B5).

For example, not as a limitation but as an example, a random token is issued as the login token by a scheme (an algorithm) that generates the random token. Next, the login code that includes the EC site URL, the issued login token, and a transmission command is generated. Further for example, data that is formed by the character string of the URL of the EC site, the character string (e.g., a parameter that beings with a symbol “?”) of the login token, the character string of the transmission command (e.g., a parameter that begins with a symbol “#”) is encoded (code) to generate the login code represented by the image of a two-dimensional code that is defined as a graphic. Moreover, in association with the communication apparatus ID of the PC 50, the login code generation flag that is “ON”, and the issued login token are stored in the communication management data 454.

Next, the login management processor 413 transmits, to PC 50 by the communication I/F 44, the login code page including the login code generated by the code generator 415 based on the communication apparatus information stored in the communication management data 454 (B7). Accordingly, the login code page is displayed on the display 53 of the PC 50 (A7).

Subsequently, the polling processor 515 of the PC 50 starts executing the polling process (A9). For example, a process of inquiring the EC server 40 of whether or not the user authentication desired to log in to the EC server 40 (the EC site) from the PC 50 is started. In response to this process, the login management processor 413 starts executing a login determination process to determine whether or not the PC 50 becomes a state capable of logging in (B9).

The login assist processor 213 executes the IMS application program 2831 included in the IMS application 283 among the plurality of IMS applications 283 stored in the storage in accordance with an IMS application starting operation given to the input and output device 23, thereby starting the IMS application (C1).

Next, the login assist processor 213 determines whether or not an IMS application code reader activating operation is given to the input and output device 23 (C3), and when determining that it is given (C3: Yes), activates the IMS application code reader that is one of the functions of the IMS application (C5).

Subsequently, the login code read processor 217 of the terminal 20 determines whether or not the two-dimensional code is read by the IMS application code reader activated in C5 (C7), and when determining that it is read (C7: Yes), executes a code information identification process (C9). For example, data is decoded (decrypted) from the read two-dimensional code to identify various kinds of information included in the read two-dimensional code.

The login code included in the login code page displayed on the PC 50 in A7 of the login process is read, and the code information identification process is executed. This causes the EC site URL, the login token, and the transmission command to be identified. When the identified information is information included in the login code, the login assist processor 213 accesses, based on the identified EC site URL, the EC site by the communication I/F 22, and transmits the communication apparatus information related to the own terminal to the EC server 40 by the communication I/F 22 (C11).

In this example, when the user taps the EC site URL on the terminal 20 to access the EC site from the terminal 20, the page of the EC site can be displayed by the individual browser (will be referred to as an “application browser” below) built in the IMS application. The login assist processor 213 transmits the information related to the application browser of the IMS application that is being executed so as to be included in the user agent information based on the transmission command received from the EC server 40, and transmits the login token identified in C9 so as to be included in the other information.

The login management processor 413 determines the communication apparatus kind based on the user agent information included in the communication apparatus information received from the terminal 20 by the communication I/F 44, associates the communication apparatus ID with this communication apparatus kind, and stores the associated information in the communication management data 454 in the storage 45. Moreover, the login token that matches the login token included in the received communication apparatus information is searched from the communication management data 454, the association flag that is “ON” is stored for each of the two communication apparatuses ID having the matched login token, and stores the one communication apparatus ID and the other communication apparatus ID in association with each other.

Subsequently, the login management processor 413 executes an IMS kind identification process (B13). For example, the IMS application (that is, an IMS kind) that has the code reader activated is identified based on the information related to the application browser in the user agent information included in the communication apparatus information received from the terminal 20. Since the IMS kind can be identified from the information related to the application browser, the information related to the application browser (not as a limitation but as example information related to the code reader that reads the code information) can be also referred to as information to identify the IMS application code reader of the terminal 20 which reads the login code, and information to identify the IMS in which the IMS application code reader of the terminal 20 that reads the login code is activated.

Note that in the above-described example, although the login assist processor 213 transmits, to the EC server 40, the information related to the application browser of the IMS application that is being executed as example information related to the code reader that reads the code information, the present disclosure is not limited to this example. In some example embodiments, the login assist processor 213 may transmit, to the EC server 40, identification information (IMS application identification information) on the IMS application that has the code reader activated, identification information (IMS identification information) on the IMS associated with this IMS application, and identification information (business operator identification information) on the business operator providing this IMS, etc., as the example information related to the code reader that reads the code information.

Subsequently, the IMS authentication information generator 417 executes an IMS authentication information generation process (B15). For example, IMS authentication information that includes, not as a limitation but as an example, the URL to access the IMS authentication site is generated using, not as limitations but as examples, a software package obtained from the IMS server 10 with the IMS kind identified in B13 among software packages which are distributed and provided by the IMS servers 10 of the respective business operators (the respective companies), and which are capable of generating information related to the authentication by the respective IMS servers 10.

Note that the information included in the IMS authentication information is not limited to information related to the URL, etc., to access the IMS authentication site as described above. For example, information like authentication inquiry command, etc., which inquires to access the IMS authentication site and to receive the IMS authentication can be included in the IMS authentication information.

Next, the login management processor 413 transmits, to the terminal 20 by the communication I/F 44, the IMS authentication information generated in B15 (B17). Next, the login assist processor 213 receives the IMS authentication information from the EC server 40 by the communication I/F 22 (C13).

Subsequently, the login assist processor 213 accesses the authentication site of the IMS server 10 by the communication I/F 22 based on the URL of the authentication site included in the received IMS authentication information, and transmits the communication apparatus information related to the own terminal to the IMS server 10 by the communication I/F 22 (C17). At this time, the login assist processor 213 includes, not as a limitation but as an example, the EC site URL in the other information, and transmits such information.

The IMS user information providing processor 113 stores the communication apparatus information received from the terminal 20 by the communication I/F 14 in the communication management data 154, and transmits the IMS authentication page to the terminal 20 by the communication I/F 14 based on the stored communication apparatus information (D1). This causes the IMS authentication page to be displayed on the display device 24 of the terminal 20 (C19).

Next, the login assist processor 213 executes a confirmation process (C21). For example, a confirmation screen that includes, not as a limitation but as an example, a message etc., to confirm that the IMS user information related to the user of the terminal 20 is to be transmitted to the EC server 40 from the IMS server 10 is displayed on the display device 24. Next, the login assist processor 213 transmits the confirmation result to the IMS server 10 by the communication I/F 22 based on the user's operation given to the confirmation screen.

Subsequently, the login assist processor 213 and the IMS user information providing processor 113 execute an IMS authentication process (not as a limitation but as an example process related to the authentication of the user of the terminal) (C23 and D3). For example, as an example, the IMS user information providing processor 113 determines whether or not the user ID and the user password both transmitted from the terminal 20 match the user ID and the user password both stored in the IMS authentication management data 153 in the storage 15, respectively. When matching, the authentication becomes OK, and when not matching, the authentication becomes NG.

Next, the IMS user information providing processor 113 executes an IMS authentication result information generation process (D5). For example, as an example, the IMS authentication code for the user who has the authentication that is OK in the IMS authentication process is generated, and the generated IMS authentication code is stored in the IMS authentication management data 153 in the storage 15 in association with the user ID of the user who has this authentication that is OK. Subsequently, the EC site URL included in the communication apparatus information received from the terminal 20 is set as a call-back URL, and IMS authentication result information that includes this call-back URL and the generated IMS authentication code is generated.

Next, the IMS user information providing processor 113 transmits the generated IMS authentication result information 155 to the terminal 20 by the communication I/F 14 (D7). The login assist processor 213 receives the IMS authentication result information 155 from the IMS server 10 by the communication I/F 22 (C25).

Subsequently, based on the call-back URL included in the received IMS authentication result information 155, the login assist processor 213 accesses again the EC site by the communication I/F 22, and transmits the communication apparatus information related to the own terminal to the EC server 40 by the communication I/F 22 (C27). At this time, the login assist processor 213 includes, not as limitations but as examples, the IMS authentication code included in the IMS authentication result information received from the IMS server 10 and the login token identified in C9 in the other information, and transmits such information.

The login management processor 413 executes a terminal appropriateness determination process (B19). For example, as an example, the communication apparatus ID is determined based on the communication apparatus information received from the terminal 20, and it is determined whether or not the login token stored in the communication management data 454 in association with the determined communication apparatus ID matches the received login token. Moreover, it is also determined whether or not the association communication apparatus ID is stored in the communication management data 454 in association with the determined communication apparatus ID. Next, when these conditions are satisfied, it is determined that the terminal 20 is appropriate.

When it is determined in the terminal appropriateness determination process that the terminal 20 is appropriate, the login management processor 413 transmits the IMS authentication code received from the terminal 20 to the IMS server 10 by the communication I/F 44, and requests the IMS user information from the IMS server 10 (B21). In this case, not as a limitation but as an example, the EC server 40 may obtain in advance information like the URL to access the site of the IMS server 10, access the IMS server 10 based on this URL, and request the IMS user information.

The IMS user information providing processor 113 executes an IMS User Information determination process (D9) when receives the request for the IMS user information from the EC server 40 by the communication I/F 14. For example, the IMS authentication code that matches the IMS authentication code received from the EC server 40 is searched from the IMS authentication management data 153 in the storage 15, and for the user with the user name stored in association with the matching IMS authentication code, the IMS user information stored in the IMS user data 152 in the storage 15 is determined.

Subsequently, the IMS user information providing processor 113 transmits, to the EC server 40 by the communication I/F 14, not as a limitation but as an example, the terminal phone number and the terminal mail address both stored in the IMS user data 152 in the storage 15 among the IMS user information determined in D9 (D11). The login management processor 413 receives the terminal phone number and the terminal mail address from the IMS server 10 by the communication I/F 44 (B23).

The IMS user information providing processor 113 determines whether or not to terminate the process (D13), and returns the process to D1 when determining to continue the process (D13: No). Moreover, when determining to terminate the process, (D13: Yes), such a processor ends the IMS user information providing process.

Subsequently, the login management processor 413 executes a login determination process (B25). For example, it is determined whether or not at least either one of the terminal phone number and the terminal mail address both received from the IMS server 10 in B23 is stored in the login management data 453 in the storage 45. Next, when at least either one of the terminal phone number or the terminal mail address is stored, a determination is made such that “login: OK”, and when both the terminal phone number and the terminal mail address are not stored, a determination is made such that “login: NG”.

In this example, even if the information that is either the terminal phone number or the terminal mail address both received from the IMS server 10 is stored in the login management data 453, when the other information is not stored in the login management data 453, the other information is to be stored in the login management data 453. That is, when the terminal phone number is absent, the terminal phone number received from the IMS server 10, etc., is stored in the login management data 453 and when the terminal mail address is absent, the terminal mail address received from the IMS server 10 is stored in the login management data 453, thereby compensating the absent information. Similarly, the absent information is stored and compensated in the EC user data 452.

When determining that the login is OK (B27: OK), the login management processor 413 transmits a login OK notification to the terminal 20 and to the PC 50 by the communication I/F 44 (B29). Conversely, when determining that login is NG (B27: NG), the login management processor 413 transmits a login NG notification to the terminal 20 and to the PC 50 by the communication I/F 44 (B31).

The login assist processor 213 executes a login result informing process (C31) when receiving the login notification from the EC server 40 by the communication I/F 22 (C29). For example, when the received login notification is the login OK notification, for example, a message indicating that the login is OK is displayed on the display device 24, thereby informing the user of the permission to login. Conversely, when the received login notification is the login NG notification, for example, a message indicating that the login is NG is displayed on the display device 24, thereby informing the user of the denial for the permission to login.

Subsequently, the login assist processor 213 determines whether or not to terminate the IMS application that is being executed (C33), and when determining to continue (C33: No), returns the process to C3. Conversely, when it is determined to terminate the process (C33: Yes), the IMS application that is being executed is terminated (C35). Hence, the login assist process is terminated.

The login processor 513 ends the polling process (A13) which is started in A9 when receiving the login notification from the EC server 40 by the communication I/F 54 (A11).

The login management processor 413 ends the login determination process (B33) which started in B9. Next, the login management processor 413 transmits the login data to the PC 50 by the communication I/F 44 (B35). For example, the login page is generated in which the login ID and the login password are entered which are stored in the login management data 453 in association with the same terminal phone number and terminal mail address as those received from the IMS server 10, and the URL to access the login page is transmitted to the PC 50 by the communication I/F 44.

When receiving the URL from the EC server 40 by the communication I/F 54 (A15), the login processor 513 accesses the login page by the communication I/F 54 based on the received URL (A17). Accordingly, the login page in which the login ID and the login password are already input is displayed on the display 53 of the PC 50.

Subsequently, the login processor 513 determines whether or not a login operation to execute the login is given on the login page (A19), and when determining that the login operation is given (A19: Yes), transmits a login execution notification execution to the EC server 40 by the communication I/F 54 (A21). Next, the login process is terminated. The login management processor 413 causes the PC 50 to log in to the EC site (B37) when receiving the login notification execution from the PC 50 by the communication I/F 44.

Next, the login management processor 413 determines whether or not to terminate the process (B39), and when determining to continue the process (B39: No), returns the process to B1. Conversely, when it is determined to terminate the process (B39: Yes), the login management process is terminated.

When determining in A19 that the login operation is not given (A19: No), the login processor 513 determines whether or not to terminate the process (A21), and when determining to continue the process (A21: No), returns the process to A19. Conversely, the login processing is terminated when it is determined to terminate the process (A21: Yes).

Note that in the above-described process, the confirmation process that is executed in C 21 by the login assist processor 213 of the terminal 20 may be executed after C11. In this case, after the terminal 20 accesses the EC site in C11, the login assist processor 213 may display, on the display device 24, a confirmation screen that includes, not as a limitation but as examples, a message to confirm the login from the PC 50 to the EC site, and a message to confirm the transmission of the IMS user information of the user of the terminal 20 to the EC server 40 from the IMS server 10, etc.

Moreover, in the login process that is executed by the login processor 513 of the PC 50, the operations in A19 to A23 may be omitted, and after the access to the login page in A17 is made, the login to the EC site may be executed automatically. In this case, once the login page is displayed, the login to the EC site may be executed automatically. Moreover, the login to the EC site may be executed automatically without the login page being displayed.

[Display Screens]

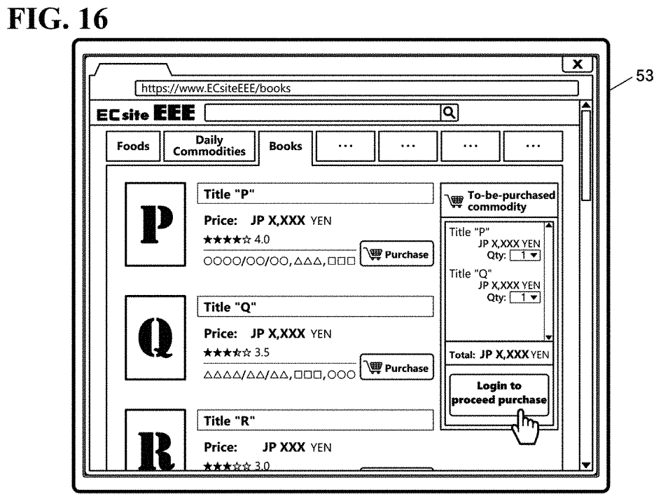

FIG. 16 is a diagram illustrating an example display screen of the EC page displayed on the display 53 of the PC 50 according to this example embodiment.

This display screen is an illustration of a display screen of a shop page displaying the commodities, etc., transitioned from the top page of the EC site (A3 in the login process) after the PC 50 accesses the EC site (A1 in the login process).

Displayed on the upper part of the screen is the name “EEE” of the EC site, and a search word enter field to enter a search word is displayed at a side of the name “EEE” of the EC site. Moreover, tags that represent the categories of commodities to be sold are displayed therebelow, and the list of commodities associated with each tag is displayed when the tag is selected. The classification of the commodity includes, not as limitations but as examples, “foods”, “daily commodities”, “books”, and the like, and a “food tag”, a “daily commodity tag”, and a “book tag”, and the like which correspond to the classification of such commodities are presented.

In example display in FIG. 16, a state in which the “book tag” is selected is illustrated, and a book with a title “P”, a book with a title “Q”, and a book with a title “R” are displayed as the commodities associated with the “book tag”. Details, such as the price and evaluation, are displayed for each book. Moreover, a “purchase button” is displayed in association with each book, and the book is placed in a shopping basket (a cart) when the “purchase button” is pressed.

Moreover, the content of the shopping basket is displayed at the to-be-purchased commodity field, and when a “proceed purchase button” indicated as “login to proceed purchase” is pressed, a determination is made that the login operation is given, and the login request information is transmitted to the EC server 40 from the PC 50 (A5 in the login process).

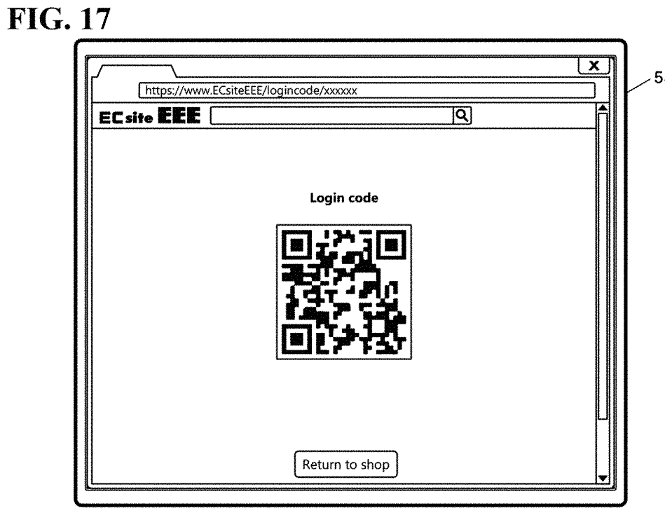

FIG. 17 is a diagram illustrating an example display screen of the login code page displayed on the display 53 of the PC 50 (A7 in the login process).

Displayed at the center in this screen is the login code represented by the image of QR code generated by the EC server 40. Moreover, a “return-to-shop” button as a button to return to the shop page is displayed at the lower part of the screen.

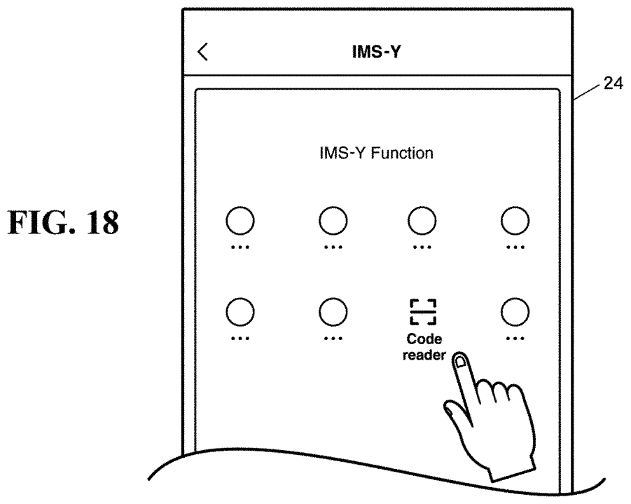

FIG. 18 is a diagram illustrating an example IMS application screen displayed on the display device 24 of the terminal 20. In this example, a state is illustrated in which the IMS application with the name “IMS-Y” is executed and an IMS application function selection screen to select the function of “IMS-Y” is illustrated.

Displayed in this IMS application function selection screen are icon images associated with the plurality of functions provided as the functions of “IMS-Y”, and among those icons, an icon image associated with the IMS application code reader is included.

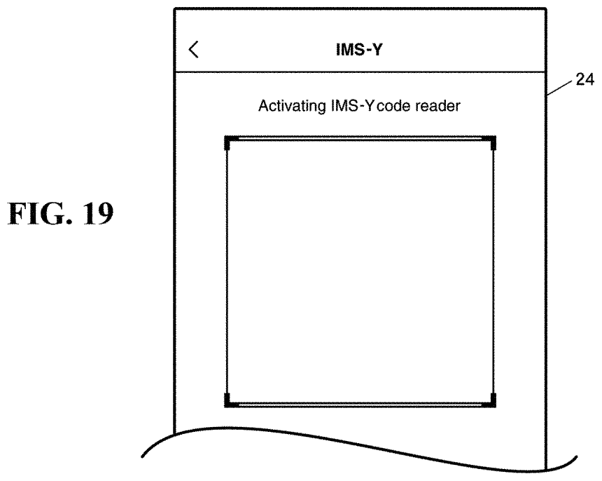

In the IMS application function selection screen in FIG. 18, when the icon image associated with the IMS application code reader is tapped by the user, an IMS-Y code reader is activated, and a reading standby screen as illustrated in FIG. 19 is displayed on the display device 24. In this state, when the terminal 20 is moved so as to place a two-dimensional code within the frame at the center of the screen, the two-dimensional code is read by the IMS-Y code reader.

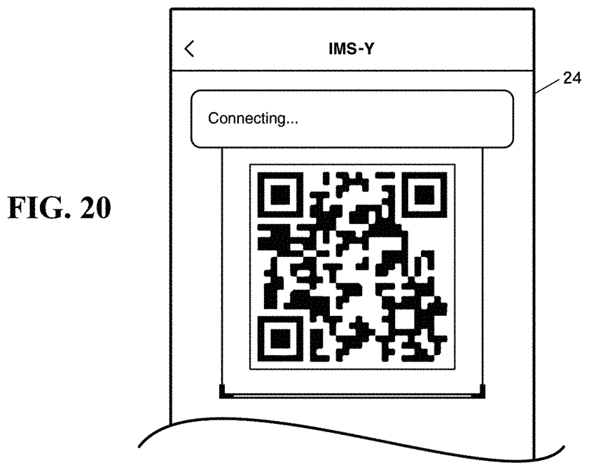

FIG. 20 is a diagram illustrating an example display screen displayed on the display device 24 when the two-dimensional code is read by the IMS-Y code reader, and illustrates a state in which the login code displayed on the PC 50 is read by the IMS-Y code reader.

When the login code displayed on the PC 50 is read by the IMS-Y code reader (C7: Yes in the login assist process), the code information identification process is executed (C9 in the login assist process), and the terminal 20 accesses the EC site based on the identified information (C11 in the login assist process). In this case, the wording “connecting” is displayed over the login code.

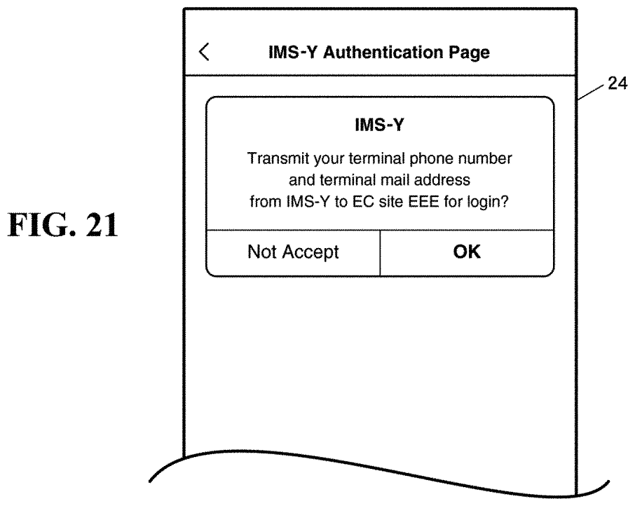

FIG. 21 is a diagram illustrating an example confirmation screen displayed on the display device 24 of the terminal 20.

This confirmation screen is displayed when the confirmation process is executed (C21 in the login assist process) in the IMS authentication page (C19 in the login process), and the wordings “IMS-Y authentication page” indicating that it is the IMS authentication page of “IMS-Y” is displayed at the upper part of the screen. Moreover, below such wordings, icons “not accept” and “OK” are displayed together with a message “transmit your terminal phone number and terminal mail address from IMS-Y to EC site EEE for login?”.

In FIG. 21, when the icon “OK” is tapped, a notification “OK” is transmitted to the IMS server 10 from the terminal 20 as the confirmation result (C21 in the login assist process). In this case, the subsequent processes are executed. Conversely, when the icon “not accept” is tapped, a notification “NG” is transmitted to the IMS server 10 from the terminal 20 as the confirmation result (C21 in the login assist process). In this case, the subsequent processes are not executed.

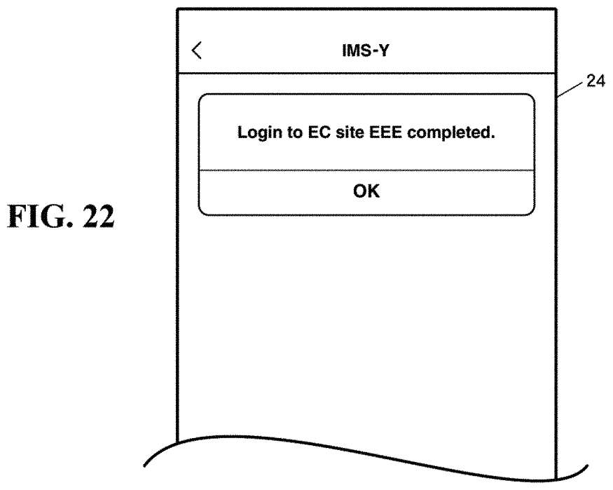

FIG. 22 is a diagram illustrating an example login result screen displayed on the display device 24 of the terminal 20.

When the login OK notification is transmitted from the EC server 40 (B29 in the login management process) and the terminal 20 receives the login OK notification (C29 in the login assist process), the login result notification process is executed (C31 in the login assist process), and the login result screen is displayed. A button “OK” is displayed in this login result screen together with a message “login to EC site EEE completed”.

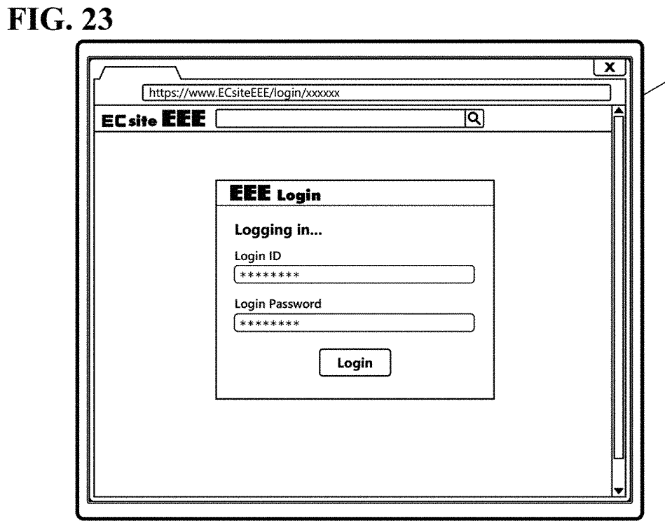

FIG. 23 is a diagram illustrating an example display screen of the login page displayed on the display 53 of the PC 50.

The login page in which the login ID and the login password are already input is displayed in this display screen (A17 in the login process). In this state, when a “login button” displayed under the login ID and the login password is pressed by the user, the login in to EC site from the PC 50 is executed (A21 in the login process, and B37 in the login management process).

Note that the displayed details in FIG. 23 are merely examples, and it is not always desired to display the details in FIG. 23.

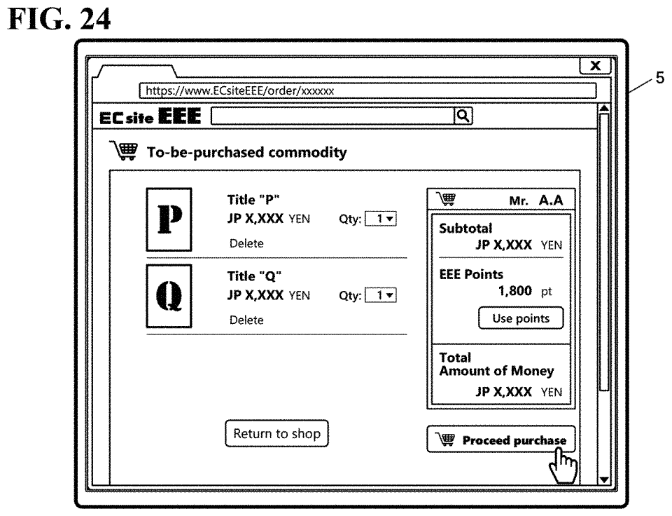

FIG. 24 is a diagram illustrating an example display screen of the shop page after the login is made to the EC site displayed on the display 53 of the PC 50. This screen is to be displayed after the “Login to proceed purchase” button is pressed in the shop page in FIG. 16, and the login is made from the login page in FIG. 23.

This display screen displays information related to a book that is a commodity put into the shopping basket as the commodity that the user wants to purchase. Moreover, a subtotal calculated from the price of the commodity put into the shopping basket, the total point (the EEE point) owned by the user, and the total amount of money calculated by adding the subtotals together are displayed at the right part of the screen. Moreover, the “proceed purchase button” is displayed therebelow, and the process progresses to the purchase process when the proceed purchase button is pressed.

[Advantageous Effects of First Example Embodiment]

The first example embodiment discloses a structure in which the login code displayed on the PC 50 (not as a limitation but as an example display apparatus) is read by the code reader of the terminal 20, and the PC 50 is caused to log in to the EC server 40 (not as a limitation but as an example first server).

An example advantageous effect accomplished by such a structure is that since the login to the first server can be made based on the common code to the service that manages the user information without causing the user to individually select the business operator of the service that manages the user information, the user friendliness can be improved.

Moreover, the first example embodiment discloses a structure in which the terminal 20 reads, by the IMS application code reader, the login code (not as a limitation but as example code information) for the login authentication (not as a limitation but as an example user authentication) to the EC sever 40 or to the EC site that enables an obtainment of the commodity, etc., (not as a limitation but as example information provided by the first server) provided by the EC server 40 (not as a limitation but as the example first server) which is displayed on the PC 50 (not as a limitation but as an example display apparatus), and transmits, to the EC server 40 by the communication I/F 22 (not as a limitation but as an example communicator of a terminal), information related to the IMS application browser which reads the login code (not as a limitation but as example information related to a code reader which reads the code information) based on the read login code.

An example advantageous effect accomplished by such a structure is that the information to identify the code reader which reads the code information, and the information to identify the service related to the code reader which reads the code information can be transmitted to the first server.

Moreover, the first example embodiment discloses a structure in which the terminal 20 receives, from the EC server 40 by the communication I/F 22, information (not as a limitation but as example information related to the service that manages the user information) to receive the IMS authentication by the IMS (not as a limitation but as an example service) managing the IMS user information (not as a limitation but as example user information) based on the information related to the IMS application browser, communicates with the IMS server 10 (not as a limitation but as an example second server) by the communication I/F 22 based on the received information to receive the IMS authentication, and executes the IMS authentication process on the user of the terminal 20 (not as a limitation but as an example process related to the authentication of the user of the terminal).

An example advantageous effect accomplished by such a structure is that the terminal communicates with the second server based on the information related to the service which manages the user information. This facilitates an execution of the process related to the authentication of the user of the terminal.

Moreover, the first example embodiment discloses a structure in which the terminal 20 displays, on the display device 24 (not as a limitation but as an example display area) of the terminal 20, information indicating that the login authentication is made (not as a limitation but as example information indicating that the user authentication is executed by the first server) based on the IMS authentication result information (not as a limitation but as example information related to the user information) that is received by the EC server 40 based on the IMS authentication process to the user of the terminal 20 with the IMS server 10.

An example advantageous effect accomplished by such a structure is that the user of the terminal is informed of the user authentication made by the first server.

Furthermore, the first example embodiment discloses a structure in which the login code includes the EC site URL (not as a limitation but as example information for causing the terminal to communicate with the first server) for causing the terminal 20 to access the EC site.

An example advantageous effect accomplished by such a structure is that the terminal can easily access the first server by simply reading the code information displayed on the display apparatus by the code reader of the terminal. Moreover, since the terminal does not need to search access information and does not need to obtain the access information from the first server, the load on the terminal can be consequently reduced.

Still further, the first example embodiment discloses a structure in which the login code includes the transmission command to transmit the information related to the code reader which reads the login code to the EC server 40 from the terminal (not as a limitation but as example information to transmit the information related to the code reader which reads the code information to the first server from the terminal).

An example advantageous effect accomplished by such a structure is that the terminal can transmit the information related to the code reader which reads the code information to the first server based on the information included in the read code information after the code information is read by the code reader.

Yet still further, the first example embodiment discloses a structure in which the login code includes the login token that associates the terminal 20 with the PC 50 (not as a limitation but as example association information).

An example advantageous effect accomplished by such a structure is that the terminal enables the first server to identify the display apparatus which reads the code information by transmitting the association information included in the code information read by the code reader to the first server.

Moreover, the first example embodiment discloses a structure in which when the IMS authentication is made to the user of the terminal 20 by the IMS server 10, the terminal 20 receives the IMS authentication result information from the IMS server 10 by the communication I/F 22, and transmits the received IMS authentication result information to the EC server 40 by the communication I/F 22.

An example advantageous effect accomplished by such a structure is that the first server can be notified of the user of the terminal being authenticated by the second server.

Furthermore, the first example embodiment discloses a structure in which the IMS authentication result information is the IMS authentication code indicating that the user of the terminal 20 has undergone the IMS authenticated by the IMS, and the terminal 20 transmits the IMS authentication code and the login token to the EC server 40 by the communication I/F 22.

An example advantageous effect accomplished by such a structure is that the first server can be notified of the user of the terminal having undergone the authentication by the second server and the terminal (or the user thereof) which has undergone the authentication by the second server having a legitimate privilege.

Still further, the first example embodiment discloses a structure in which the login token includes the token that is different every time the login code is displayed on the PC 50.

An example advantageous effect accomplished by such a structure is that the privilege which is unique to each terminal (or the user thereof) that reads the code information can be given.

Yet still further, the first example embodiment discloses a structure in which the login code is information to log in to the EC server 40 in order to obtain the commodity, etc., provided by the EC server 40.

An example advantageous effect accomplished by such a structure is that the login to the first server is facilitated by simply reading the code information displayed on the display apparatus by the terminal. Moreover, since an extra operation at the terminal is not desired, the user friendliness can be improved, thereby suppressing a user's incorrect operation.

Moreover, the first example embodiment discloses a structure in which the PC 50 displays the login code on the display 53, and based on the IMS authentication process to the user of the terminal 20 with the IMS server 10, displays, on the display 53, the information indicating that login is permitted by the EC server 40 in accordance with the IMS authentication result information received by the EC server 40.

An example advantageous effect accomplished by such a structure is that the user of the terminal can be informed of the user authentication made by the first server.

Furthermore, the first example embodiment discloses a structure in which the PC 50 executes the polling process inquires the EC server 40 of the permission to login by the EC server 40 when displaying the login code on the display 53.

An example advantageous effect accomplished by such a structure is that the notification indicating that the user authentication is executed by the first server can be given from the first server, and the information provided from the first server can be promptly obtained after the notification is given.

Still further, the first example embodiment discloses a structure in which the EC server 40 transmits, to the PC 50 (not as a limitation but as an example display apparatus) by the communication I/F 44, the login code (not as a limitation but as example code information) for the login authentication (not as a limitation but as an example user authentication) that enables an obtainment of the commodity, etc., provided by the EC server 40, and receives, based on the login code that is read by the IMS application code reader (not as a limitation but as an example code reader) of the terminal 20, the information related to the IMS application browser in which the login code is read (not as a limitation but as example information related to the code reader which reads the code information) from the terminal 20 by the communication I/F 44 (not as a limitation but as an example communicator of the first server).

An example advantageous effect accomplished by such a structure is that the first server can easily identify the code reader which reads the code information or the service associated with the code reader which reads the code information.

Yet still further, the first example embodiment discloses a structure in which the EC server 40 transmits, to the terminal 20 by the communication I/F 44, the information to receive the IMS authentication (not as a limitation but as example information related to the service that manages the user information) by the IMS (not as a limitation but as an example service) managing the IMS user information (not as a limitation but as example user information) based on the information related to the IMS application browser, and receives, by the communication I/F 44, the IMS authentication result information (not as a limitation but as example information related to the user information) based on the IMS authentication process (not as a limitation but as an example process related to the authentication of the user of the terminal) by the communication between the terminal 20 that receives the information to receive the IMS authentication and the IMS server 10.

An example advantageous effect accomplished by such a structure is that the first server can easily grasp that the user of the terminal is authenticated by the second server.

Moreover, the first example embodiment discloses a structure in which, based on the IMS authentication result information that is received by the communication I/F 44, the EC server 40 transmits the information indicating that the login authentication is made (not as a limitation but as example information indicating that the user authentication is executed by the first server) to the terminal 20 by the communication I/F 44.

An example advantageous effect accomplished by such a structure is that the user of the terminal can be informed of the user authentication executed by the first server.

Furthermore, the first example embodiment discloses a structure in which the login code includes the EC site URL for causing the terminal 20 to access the EC site (not as a limitation but as example information for causing the terminal to communicate with the first server).

An example advantageous effect accomplished by such a structure is that the terminal is enabled to easily access the first server based on the login code that is transmitted to the display apparatus.

Still further, the first example embodiment discloses a structure in which the login code includes the transmission command to transmit the information related to the code reader which reads the login code to the EC server 40 from the terminal 20.

An example advantageous effect accomplished by such a structure is that the first server can transmit the information related to the read code reader to the terminal which reads the code information transmitted to the display apparatus. Moreover, since an additional notification to the terminal so as to transmit the information related to the code reader is not desired, consequently, the communication traffic of the first server can be reduced, thereby reducing the load on the first server.

Yet still further, the first example embodiment discloses a structure in which the login code includes the login token that associates the terminal 20 with the PC 50 (not as a limitation but as example association information).

An example advantageous effect accomplished by such a structure is that the first server can easily identify the display apparatus which reads the code information by receiving, from the terminal, the association information included in the code information read by the code reader.

Moreover, the first example embodiment discloses a structure in which, when the user of the terminal 20 has undergone the IMS authentication by the IMS server 10, the EC server 40 receives, based on the IMS authentication result information that is received from the IMS server 10 by the terminal 20, the IMS authentication result information transmitted from the terminal 20 by the communication I/F 44.

An example advantageous effect accomplished by such a structure is that it can be grasped that the user of the terminal has undergone the authentication by the second server.

Moreover, the first example embodiment discloses a structure in which the IMS authentication result information is the IMS authentication code indicating that the user of the terminal 20 has undergone the IMS authentication by the IMS, and the EC server 40 receives the IMS authentication code and the login token transmitted from the terminal 20 by the communication I/F 44.

An example advantageous effect accomplished by such a structure is that the first server can grasp that the user of the terminal has undergone the authentication by the second server and the terminal having undergone the authentication by the second server is the terminal which has a litigate privilege.

Furthermore, the first example embodiment discloses a structure in which the login code is the information to log in to the EC server 40 (the EC site) in order to obtain the commodity, etc., provided by the EC server 40.

An example advantageous effect accomplished by such a structure is that the login to the first server is facilitated by simply causing the terminal to read the code information transmitted to the display apparatus.

### First Modified Example (1)

Although the description has been given in the first example embodiment that the user authentication that enables an obtainment of the information provided by the first server according to the present disclosure is the authentication of log in to the EC server 40, the present disclosure is not limited to this example. Not as a limitation but as an example, a desired authentication of obtaining an account like the login ID desired to utilize the EC may be taken as the user authentication according to the present disclosure.

Moreover, although the description has been given in the first example embodiment that the process related to the authentication of the user of the terminal according to the present disclosure is the process which is executed by the IMS server 10 and which is to authenticate that the user of the terminal 20 is the litigate user of the IMS, the present disclosure is not limited to this example. Not as a limitation but as an example, processes to obtain an ID desired to utilize the particular functions of the IMS, such as a function to add a user (a friend) who becomes a friend in the IMS, and a function to search another user whom the user wants to be a friend, may be the process related to the authentication of the user of the terminal according to the present disclosure.

[Advantageous Effect of First Modified Example (1)]

An example advantageous effect accomplished by this modified example is that the user of the terminal can easily obtain, by simply reading the code information displayed on the display apparatus by the code reader of the terminal, the information desired to obtain the information provided by the second server, and the information desired to utilize the particular function of the service by the second server, etc., without selecting the business operator of service that manages the user information.

### First Modified Example (2)

According to the first example embodiment, although the first server according to the present disclosure is the EC server 40, the present disclosure is not limited to this example. Any server of the business operator which stores the user information associated with the IMS user information stored in the IMS server 10, and which provides any kind of information may be the first server according to the present disclosure.

Similarly, according to the first example embodiment, although the second server according to the present disclosure is the IMS server 10, the present disclosure is not limited to this example. Any server of the business operator which stores the user information associated with the EC user information stored in the EC server 40, and which provides any kind of service may be the second server according to the present disclosure.

For example, not as a limitation but as an example, an SNS server may be constructed as a server that stores and manages the user information related to the user who utilizes the above-described SNS (SNS user information), and information desired for the user to utilize the SNS, and this SNS server may be the second server according to the present disclosure.

[Advantageous Effect of First Modified Example (2)]

An example advantageous effect accomplished by this modified example is that the server which provides the service other than the EC may be the first server, the server which provides the service other than the IMS may be the second server, and this first server may execute the user authentication.

### First Modified Example (3)

According to the first example embodiment, although the login code displayed on PC 50 is read by the IMS application code reader activated at the terminal 20 to log in to the EC server 40 from the PC 50, the present disclosure is not limited to this example. Not as a limitation but as an example, the login code displayed on the one terminal 20 may be read by the IMS application code reader activated at the other terminal 20 so as to enable the login to the EC server 40 from the one terminal 20.

Moreover, it is not always desired for the user to own the terminal 20 and the PC 50 as a set, and the login code displayed on the PC 50 which is not owned by the user may be read by the IMS application code reader activated at the terminal 20 owned by the user to enable the login to the EC server 40 from this PC 50.

[Advantageous Effect of First Modified Example (3)]

An example advantageous effect accomplished by this modified example is that the communication apparatus (the display apparatus) other than the PC can access the first server to receive the user authentication.

### First Modified Example (4)

According to the first example embodiment, although the login code is described as the two-dimensional code, the present disclosure is not limited to this example. Not as a limitation but as an example, the login code may be a one-dimensional code (a bar code), and such a code may be read by a one-dimensional code reader (a bar code reader). Moreover, the login code may be a character code represented by a character string, such as a URL, a login token, and a transmission command, and such a code may be read by the camera, etc., of the terminal 20 to identify the information included in the login code.

[Advantageous Effect of First Modified Example (4)]

This modified example facilitates the login to the EC server 40 (the EC site) from the PC 50 by simply reading the login code other than the two-dimensional code by the terminal 20.

### First Modified Example (5)

According to the first example embodiment, although the EC server 40 stores, in the communication management data 454 based on the login token, the PC identification information (the communication apparatus ID of the PC 50) to identify the PC 50 and the terminal identification information (the communication apparatus ID of the terminal 20) to identify the terminal 20 in association with each other, the present disclosure is not limited to this example.

For example, the EC server 40 may store, in the communication management data 454 based on the login token, browser identification information to identify the browser of the PC 50 and The IMS application identification information to identify the IMS application executed at the terminal 20 in association with each other. Moreover, as a combination of the above examples, the EC server 40 may store the PC identification information and the IMS application identification information in the communication management data 454 based on the login token. Furthermore, the browser identification information and the terminal identification information may be stored in association with each other.

Moreover, the EC server 40 may store, instead of the terminal identification information (the communication apparatus ID of the terminal 20) to identify the terminal 20, the user identification information to identify the user of the terminal 20 in association with the information to identify the PC 50.

In this case, not as a limitation but as an example, the user of the terminal 20 may register either one of the terminal phone number or the terminal mail address in the EC server 40 as the user identification information at the time of initial registration. In addition, not as a limitation but as an example, information, such as the name of the user of the terminal 20, and the address thereof, etc., may be registered in the EC server 40 as the user identification information.

Next, when the terminal 20 which reads the login code communicates with the EC server 40, in addition to the login token, not as a limitation but as an example, the information which is not registered in the EC server 40 is transmitted to the EC server 40. When, for example, either one of the terminal phone number or the terminal mail addresses is registered, the other information not registered yet is transmitted to the EC server 40. Moreover, when, for example, either one of the name of the user of the terminal 20 or the addresses is registered, the other information not registered yet is transmitted to the EC server 40.

The EC server 40 stores, in the communication management data 454, the information received from the terminal 20 as the user identification information in association with the information to identify the PC 50 (the communication apparatus ID of the PC 50 or the browser identification information of the PC 50). This enables the EC server 40 to associate (relate) the user of the terminal 20 with the PC 50.

[Advantageous Effect of First Modified Example (5)]

An example advantageous effect accomplished by this modified example is that the first server can associate the terminal with the display apparatus using not only the PC identification information and the terminal identification information but also the browser identification information and the IMS application identification information. Moreover, when the association of the terminal with the display apparatus is executed, the association of the user of the terminal with the display apparatus can be also executed.

### First Modified Example (6)

According to the first example embodiment, the description has been given that, when the IMS authentication is executed by the IMS server 10, the terminal 20 transmits, to the EC server 40, the IMS authentication code transmitted from the IMS server 10. That is, although the description has been given that the EC server 40 indirectly receives the IMS authentication code from the IMS server 10 through the terminal 20 (this will be referred to as an “indirect call-back”), the present disclosure is not limited to this example.

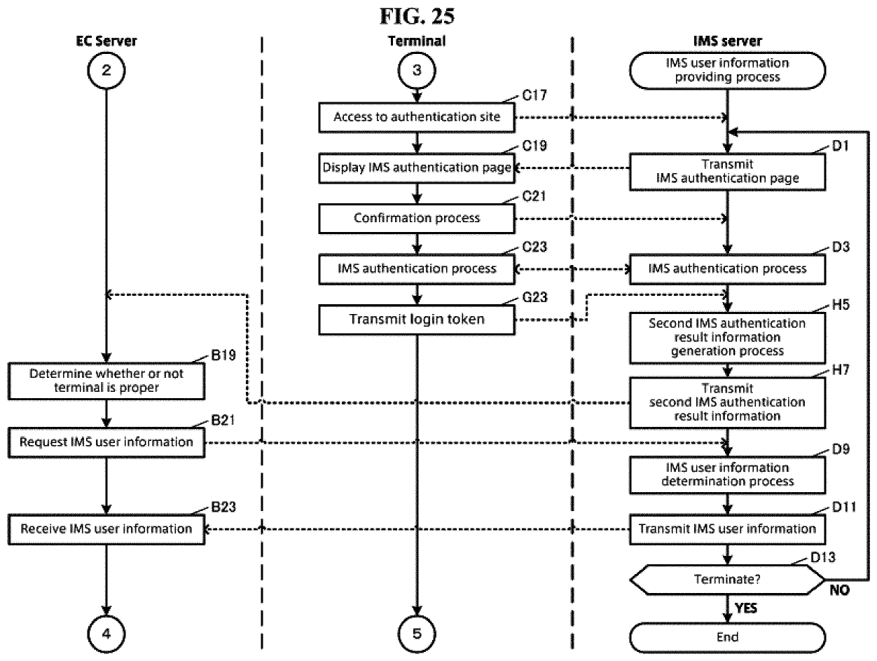

FIG. 25 is extracted process portions in FIG. 14 among the process flows in this case. Note that the operation as that of FIG. 14 will be denoted by the same reference numeral, and the description thereof will be omitted.

The login assist processor 213 of the terminal 20 transmits the login token to the IMS server 10 by the communication I/F 22 (G23) after executing the IMS authentication process in C23. Not as a limitation but as an example, the terminal 20 transmits, in the operation G23 in addition to the login token, the EC site URL to access the EC site to the IMS server 10. Next, the IMS user information providing processor 113 of the IMS server 10 stores the EC site URL received from the terminal 20 in the storage 15.

Note that instead of transmitting the EC site URL to the IMS server 10 in the operation G23 as described above, at an arbitrary timing before G23, the terminal 20 may transmit the EC site URL to the IMS server 10. Moreover, instead of causing the terminal 20 to transmit the EC site URL to the IMS server 10, the EC server 40 may transmit the EC site URL to the IMS server 10 in advance to notify.

The IMS user information providing processor 113 of the IMS server 10 executes a second IMS authentication result information generation process (H5) when receiving, by the communication I/F 14, the login token from the terminal 20. For example, information that includes the IMS authentication code and the login token received from the terminal 20 is generated as second IMS authentication result information.

Next, the IMS user information providing processor 113 of the IMS server 10 accesses the EC site based on the EC site URL that is stored in the storage 15, and transmits the second IMS authentication result information generated in H5 to the EC server 40 by the communication I/F 14 (H7). That is, in this case, the EC server 40 directly receives the IMS authentication result information from the IMS server 10 (this will be referred to as “direct call-back”).

Moreover, in this case, the login management processor 413 of the EC server 40 returns, after receiving the second IMS authentication result information from the IMS server 10, the IMS authentication code included in the received second received IMS authentication result information to the IMS server 10 by the communication I/F 44 to request, to the IMS server 10, the IMS user information. Next, the login management processor 413 receives the IMS user information transmitted from the IMS server 10, and executes the login determination process (B25 in FIG. 15).

Furthermore, in this case, after the login management processor 413 executes the login determination process (B25 in FIG. 15), instead of directly transmitting the login notification (the login OK notification or the login NG notification) to the terminal 20 based on the determined result, the login notification (the login OK notification or the login NG notification) may be indirectly transmitted to the terminal 20 through the IMS server 10.

For example, the login management processor 413 transmits, to the IMS server 10 by the communication I/F 44, the login notification (the login OK notification or the login NG notification) based on the determination result after executing the login determination process (B25 in FIG. 15). Next, the IMS user information providing processor 113 of the IMS server 10 transmits the login notification received from the EC server 40 by the communication I/F 14 to the terminal 20 by the communication I/F 14.

[Advantageous Effect of First Modified Example (6)]

This modified example discloses a structure in which when the IMS authentication is executed to the user of the terminal 20 by the IMS server 10, the terminal 20 displays, based on the IMS authentication result information that is transmitted from the IMS server 10 being received by the EC server 40, the information indicating whether the login to the EC server 40 is OK or NG (the information indicating that the user authentication is executed by the first server) on the display device 24 (the display area) of the terminal 20.

An example advantageous effect accomplished by such a structure is that the user of the terminal can be notified of the user authentication executed by the first server.

Moreover, this modified example discloses a structure in which the IMS authentication result information is the IMS authentication code indicating that the IMS authentication by the IMS is executed to the user of the terminal 20, and the terminal 20 displays, based on the IMS authentication code and the login token that are received by the EC server 40, the information indicating whether the login to the EC server 40 is OK or NG (the information indicating that the user authentication is executed by the first server) on the display device 24 (the display area) of the terminal 20.

An example advantageous effect accomplished by such a structure is that the user of the terminal can be notified of the user authentication being executed by the first server. Moreover, the information indicating that the user of the terminal is authenticated by the second server may not need to be transmitted, and the association information to the first server from the terminal, and thus the load on the terminal can be reduced consequently.

Furthermore, this modified example discloses a structure in which when the EC server 40 determines whether or not the user information is proper, the terminal 20 displays, based on the login notification that is transmitted from the IMS server 10 being received by the communication I/F 22, the information indicating whether the login to the EC server 40 is OK or NG (the information indicating that the user authentication is executed by the first server) on the display device 24 (the display area) of the terminal 20.

An example advantageous effect accomplished by such a structure is that the user of the terminal can be notified of the user authentication executed by the first server. Moreover, since there is no need to inquire the first server of the user authentication result, the load on the terminal can be reduced consequently.

Still further, this modified example discloses a structure in which the EC server 40 receives the IMS authentication result information transmitted from the IMS server 10 by the communication I/F 44 when the IMS authentication by the IMS server 10 is executed to the user of the terminal 20.

An example advantageous effect accomplished by such a structure is that the first server can grasp that the user of the terminal is authenticated by the second server without communicating with the terminal.

Yet still further, this modified example discloses a structure in which the IMS authentication result information is the IMS authentication code indicating that the IMS authentication by the IMS to the user of the terminal 20 is executed, and the IMS authentication code transmitted from the IMS server 10, and the login token transmitted from the IMS server 10 are received by the communication I/F 44.

An example advantageous effect accomplished by such a structure is that the first server can grasp that the user of the terminal is authenticated by the second server without communicating with the terminal, and can obtain the authentication information unique to the terminal or to the user of the terminal.

Moreover, this modified example discloses a structure in which the EC server 40 notifies, by the communication I/F 44, the IMS server 10 of the login notification indicating that the EC server 40 executes the login authentication.

An example advantageous effect accomplished by such a structure is that the first server can directly notify the second server of the execution of the user authentication without through the terminal.

### First Modified Example (7)

According to the first example embodiment, when receiving the IMS user information for login from the IMS server 10, the EC server 40 may execute a process of paying a predetermined amount of money to the business operator of the IMS server 10 as a consideration for the received IMS user information. Moreover, a process related to the setting for the amount of money to be paid to the business operator of the IMS server 10 can be executed.

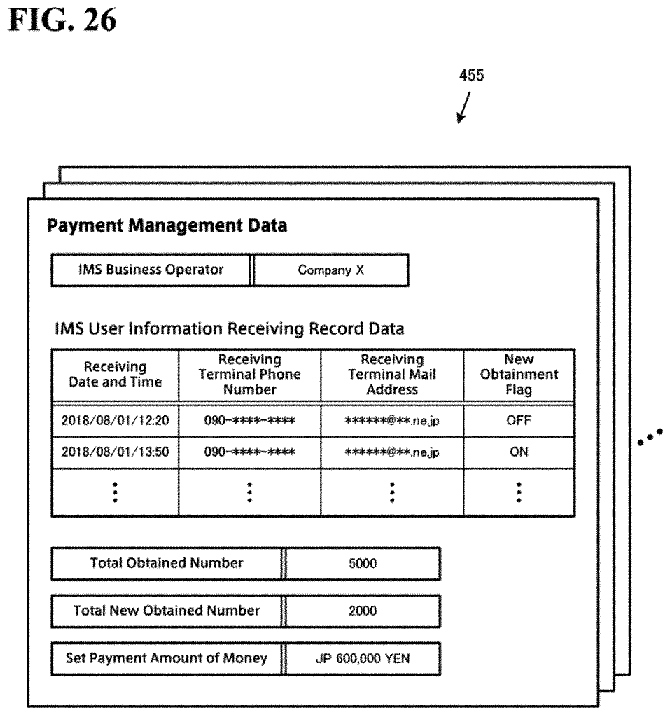

FIG. 26 is a diagram illustrating an example data structure of a payment management database 455 stored in the storage 45 of the EC server 40 in this case.

Stored in the payment management database 455 is payment management data generated for each business operator of the IMS server 10.

Stored in each piece of payment management data are the IMS business operator, IMS user information receiving record data, a total obtained number, a total new obtained number, and a set payment amount of money.

The name of the business operator (the name of the company) providing the IMS is stored in the IMS business operator.

A receiving date and time at which the IMS user information is received, a receiving terminal phone number that is the phone number of the receiving terminal, a receiving terminal mail address that is the mail address of the receiving terminal, and a new obtainment flag are stored in the IMS user information receiving record data in association with each other. In this example, the description will be given of a case in which the EC server 40 obtains the IMS user information related to the individual user one by one from the IMS server 10, and stores such information in the IMS user information receiving record data.

As described in the first example embodiment, when either information that is the terminal phone number or the terminal mail address received from the IMS server 10 is stored in the login management data 453, but the other information is not stored in the login management data 453, the EC server 40 stores the other information in the login management data 453 to compensate. The new obtainment flag indicates whether or not such information compensation is executed, is set to “ON” when either the terminal phone number or the terminal mail address is compensated, and is set to “OFF” when the information is not compensated.

The obtained number stores the total number of the record of the data stored in the IMS user information receiving record data with the data of one record among the pieces of the data stored in the IMS user information receiving record data being as one. This total obtained number can be referred to as the number of times that the EC server 40 receives the IMS user information from the IMS server 10, or the number of times that the IMS server 10 transmits the IMS user information to the EC server 40.

The total new obtained number is the total number of the new obtainment flags that are set to “ON” and stored in the IMS user information receiving record data. This total new obtained number can be also referred to as the number of times that the EC server 40 receives the new IMS user information from the IMS server 10, or the number of times that the IMS server 10 transmits the new IMS user information to the EC server 40.

The set payment amount of money is the amount of money set as the amount of money to be paid to the business operator of the IMS server 10, and is decided based on the total obtained number and on the total new obtained number. Note as a limitation but as an example, the set payment amount of money may be calculated and decided as “set payment amount of money=total obtained number×JP 100 YEN+total new obtained number×JP 50 YEN” with “JP 100 YEN” per an obtained number, and “JP 50 YEN” per a new obtained number.

Note that the EC server 40 may receive, in addition to the terminal phone number and to the terminal mail address, IMS user information, such as the number of persons registered as friends by the user of the terminal 20 in the IMS, the number of times of utilization of the IMS by the user of the terminal 20, and the frequency of utilization, from the IMS server 10, and the above-described set payment amount of money may be decided based on the kinds of these pieces of the IMS user information. In this case, not as a limitation but as an example, when the IMS user information of the other kinds than the terminal phone number or the terminal mail address is obtained from the IMS server 10, the set payment amount of money may be calculated in such a way that “JP 50 YEN” is added per a kind.

Moreover, the above-described set payment amount of money may be decided based on not the number of times that the IMS user information is transmitted to the EC server 40 from the IMS server 10 but the frequency that the IMS user information is transmitted to the EC server 40 from the IMS server 10. In this case, the higher the frequency that the IMS user information is transmitted to the EC server 40 from the IMS server 10 is, the higher the set payment amount of money is to be calculated.

Furthermore, in the above example, the EC server 40 may obtain, from the IMS server 10, the IMS information related to two or more users per a time, and may store the obtained information in the above-described IMS user information receiving record data.

[Advantageous Effect of First Modified Example (7)]

This modified example discloses a structure in which the EC server 40 executes the process related to the setting of the amount of money to be paid to the business operator of the IMS server 10 based on the IMS user information that is transmitted to the EC server 40 from the IMS server 10.

An example advantageous effect accomplished by such a structure is that the first server can pay the amount of money as the consideration of the obtained user information to the business operator of the second server the amount of money, and can set the amount of money to be paid.

Moreover, this modified example discloses a structure in which the process related to the setting of the amount of money to be paid includes the process of deciding the amount of money to be paid to the business operator of the IMS server 10 based on the number of times that the IMS user information is transmitted to the EC server 40 from the IMS server 10, the number of the IMS user information transmitted to the EC server from the IMS server 10, or the kind of the IMS user information transmitted to the EC server 40 from the IMS server 10.

An example advantageous effect accomplished by such a structure is that the first server can make the amount of money to be paid to the business operator of the second server appropriate.

Note that in the above-described example, the EC server 40 executes the process of paying the amount of money to the business operator of the IMS server 10, and the process related to the setting of the amount of money to be paid to the business operator of the IMS server 10. Conversely, the IMS server 10 may execute the process of charging the business operator of the EC server 40 so as to pay the amount of money as the consideration for the IMS user information transmitted to the EC server 40, and the process related to the setting of the amount of money to be charged to the business operator of the EC server 40. The term “charging” means to give a liability for the other party to pay the amount of money (to cause the other party to accept the payment of the amount of money).

In this case, like the above-described scheme, the amount of money to be charged to the business operator of the EC server 40 may be decided based on the number of times (or the frequency) of transmitting the IMS user information to the EC server 40 from the IMS server 10, the number of the IMS user information transmitted to the EC server 40 from the IMS server 10, or the kind of the IMS user information transmitted to the EC server 40 from the IMS server 10, etc.

This modified example discloses a structure in which the IMS server 10 executes the process related to the setting of the amount of money to be charged to the business operator of the EC server 40 based on the IMS user information that is transmitted to the EC server 40 from the IMS server 10.

An example advantageous effect accomplished by such a structure is that the second server can charge the business operator of the first server as the consideration for the provided user information, and can set the amount of money to be charged.

Moreover, this modified example discloses a structure in which the process related to the setting of the amount of money to be charged includes the process of deciding the amount of money to be charged to the business operator of the EC server based on the number of times (or the frequency) of transmitting the IMS user information to the EC server 40 from the IMS server 10, the number of the IMS user information transmitted to the EC server 40 from the IMS server 10, or the kind of the IMS user information transmitted to the EC server 40 from the IMS server 10.

An example advantageous effect accomplished by such a structure is that the second server can make the amount of money to be charged to the business operator of the first server appropriate.

### Second Example Embodiment

A second example embodiment accompanies with the first example embodiment, and when the login code is read by a code reader other than the IMS application code reader at the terminal 20, a login is made. The same structure as that of the first example embodiment will be denoted by the same reference numeral, and the description thereof will be omitted.

The details to be described in the second example embodiment are applicable to each of the other example embodiments.

According to the first example embodiment, the terminal 20 reads the login code using the code reader built in the IMS application. However, there may be a case in which the user reads the login code by a code reader, such as the code reader originally provided for the terminal 20, and the code reader which is provided by a third organization (a third party) other than the business operator of the IMS server 10. In this case, there is a problem such that the EC server 40 cannot determine where the IMS user information desired for login should be obtained.

Hence, when the code reader identified from the information received from the terminal 20 is the code reader other than the IMS application code reader, the control device 41 of the EC server 40 notifies the terminal 20 of the fact that the kind of the IMS is unidentifiable, and transmits, to the terminal 20, a screen (referred to as a “login IMS selection screen” below) for causing the user to select the IMS (the IMS server 10) where the IMS user information desired for login is obtained to cause the terminal to display such a screen. Next, the control device 21 of the terminal 20 transmits, to the EC server 40, the identification information related to the IMS selected by the user in the login IMS selection screen, and the login token identified from the read login code.

The control device 41 of the EC server 40 determines the IMS server 10 to which the IMS user information is requested based on the identification information related to the IMS received from the terminal 20. Next, the IMS user information is received from the determined IMS server 10, and the PC 50 is caused to log in to the EC site based on the received IMS user information.

[Display Screens]

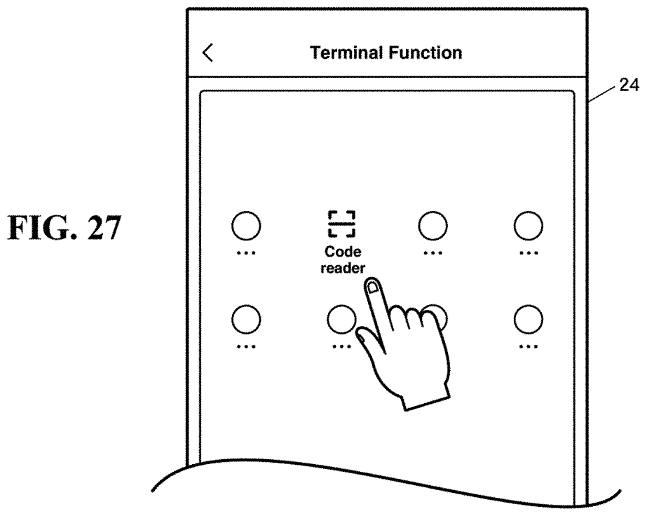

FIG. 27 is a diagram illustrating an example terminal function selection screen displayed on the display device 24 of the terminal 20.

Icon images associated with the plurality of functions of the terminal 20 are displayed in this function selection screen, and the icon image of the code reader is included in such icons. This code reader may be the code reader originally provided for the terminal 20, or may be a code reader which is obtained from a third organization (a third party) other than the business operator of the IMS server 10, and becomes available for the terminal 20.

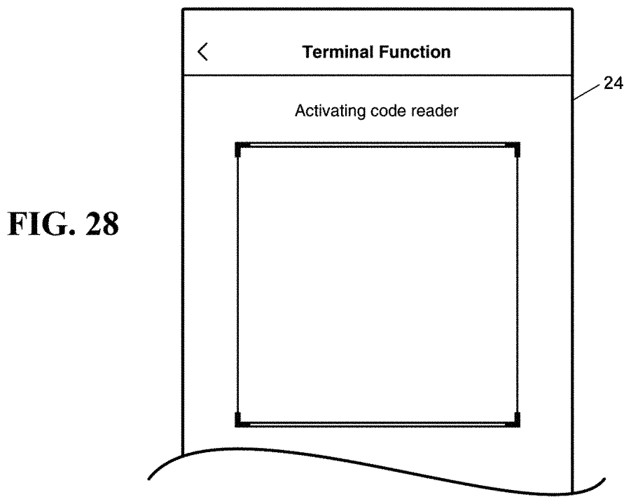

In the above-described terminal function selection screen, when the icon image associated with the code reader is tapped by the user, the code reader of the terminal 20 is activated and a reading standby screen as illustrated in FIG. 28 is displayed. In this state, by moving the terminal 20 in such a way that a two-dimensional code is located within a frame at the center of the screen, the two-dimensional code is read by the code reader.

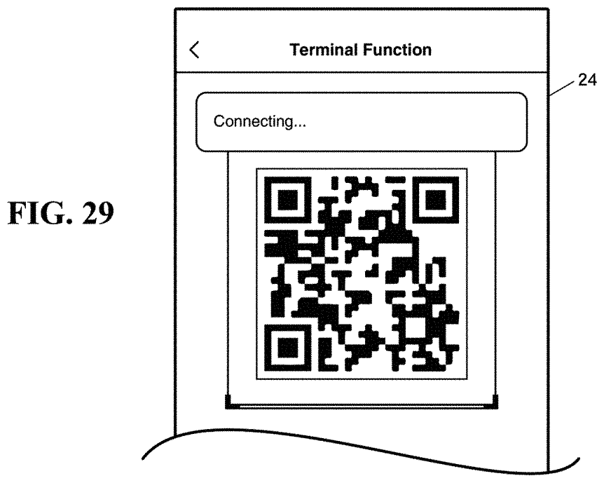

FIG. 29 is a diagram illustrating a state in which the two-dimensional code is read by the code reader of the terminal 20, and illustrating a state in which the login code displayed on the PC 50 is read by the code reader of the terminal 20.

When the login code displayed on the PC 50 is read by the code reader of the terminal 20 (C7 in the login assist process: Yes), the code information identification process is executed (C9 in the login assist process), and the terminal 20 accesses the EC site based on the identified information (C11 in the login assist process). In this case, the wordings “connecting . . . ” is displayed above the login code.

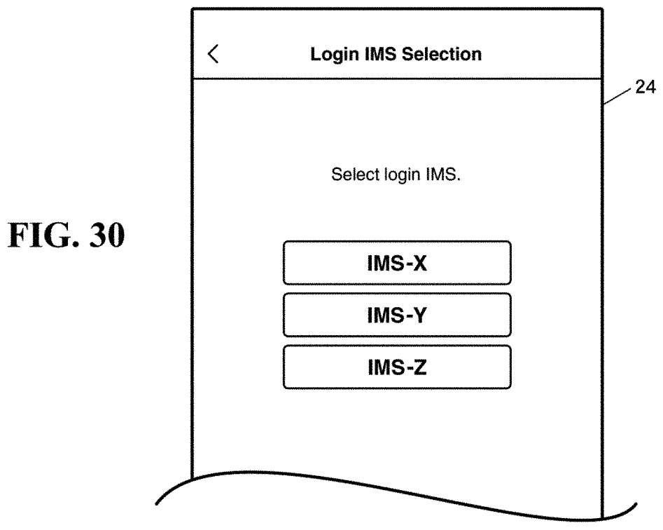

FIG. 30 is a diagram illustrating an example login IMS selection screen displayed on the display device 24 of the terminal 20. This login IMS selection screen is transmitted to the terminal 20 from the EC site 40 and is displayed after the screen in FIG. 29 is displayed.

IMS icons corresponding to the three kinds of the IMS that are “IMS-X”, “IMS-Y”, and “IMS-Z” are displayed in this login IMS selection screen together with a message “select login IMS”. When any one of the IMS icons is tapped by the user, the identification information related to the IMS corresponding to the tapped IMS icon, and the login token are transmitted to the EC server 40 from the terminal 20.

[Advantageous Effect of Second Example Embodiment]

The second example embodiment discloses a structure to which the terminal 20 executes a display related to the selection of the IMS that stores the user information related to the display device 24 when the kind of the IMS is not identified by the information related to the code reader which reads the login code.

An example advantageous effect accomplished by such a structure is that the user is enabled to decide the source from which the desired user information for the user authentication by the first server is obtained.

Moreover, the second example embodiment discloses a structure in which the EC server 40 receives a notification from the terminal 20 when the code reader identified by the information received from the terminal 20 is the code reader of the business operator that does not store the desired user information for login.

An example advantageous effect accomplished by such a structure is that the first server can identify the source from which the desired user information for the user authentication is obtained, and obtains the user information from the identified obtainment source to execute the user authentication.

Furthermore, the second example embodiment discloses a structure in which the EC server 40 notifies the terminal 20 of the kind of the IMS unidentifiable when the kind of the IMS is not identified by the information related to the code reader that reads the login code.

An example advantageous effect accomplished by such a structure is that the user is enabled to select the service from which the user information utilized for the user authentication is obtained.

### Third Example Embodiment

A third example embodiment accompanies with the first example embodiment, and information related to the information provided by the EC server 40 is included in the login code generated by the EC server 40, and the information related to the information provided by the EC server 40 is collected based on the information that is transmitted from the terminal 20 which reads the login code by the code reader.

The details described the third example embodiment are applicable to each of the other example embodiments.

[Functional Structure]

According to this example embodiment, the control device 41 of the EC server 40 includes a commodity information collector in addition to the functional blocks illustrated in FIG. 5.

A commodity information collector has a function to detect from which commodity category or commodity page among the EC pages displayed on the PC 50 the login to the EC server 40 (the EC site) is made, and to execute a process of collecting the detection results.

[Processes]

According to this example embodiment, the code generator 415 of the EC server 40 generates, when the login request is received from the PC 50, the login code which is a QR code that includes the EC site URL (the access information), the login token (the association information), the transmission command (the transmission request information), and commodity category identification information to identify the category of the commodity (referred to as a “commodity category” below) that is displayed when the PC 50 logs in to the EC site.

Not as a limitation but as an example, in the display screen of the shop page illustrated in FIG. 16, as the commodity categories to be sold at the EC site, “foods”, “daily commodities”, “books”, and the like are present, and as the tags corresponding to these commodity categories, a “food tag”, a “daily commodity tag”, and “a book tag”, and the like are displayed.

The EC server 40 stores, in the storage 45 in advance in association with these commodity categories, commodity category IDs each to identify each commodity category. Next, with the shop page being displayed, when the login request is received from the PC 50 based on the fact that the “login to proceed purchase button” is pressed, the code generator 415 of the EC server 40 determines the commodity category associated with the tag selected in this shop page, and generates the login code including the commodity category ID that is stored in the storage 45 in association with the determined commodity category.

When the tag related to the commodity category is selected in the shop page, a page that is a list of the commodities with the commodity category associated with the selected tag is displayed. Hence, the commodity category identification information to identify the commodity category can be referred to as page identification information to identify the page of the commodity category.

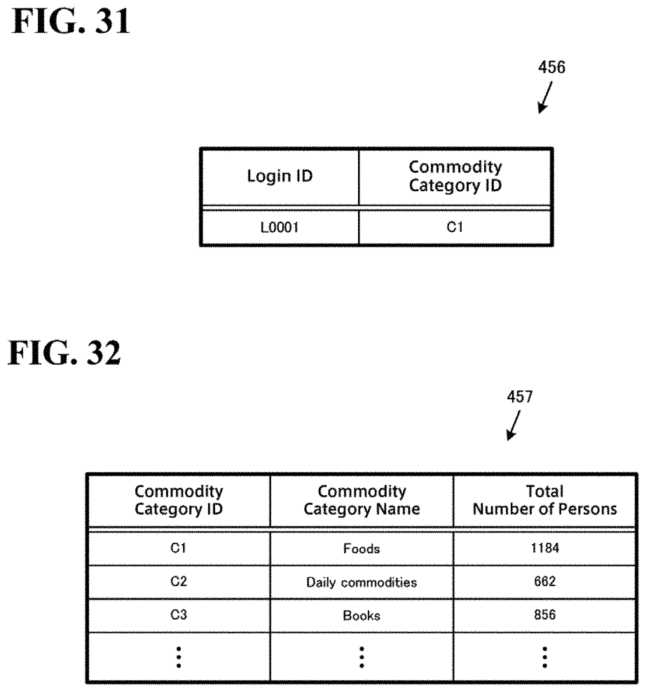

FIG. 31 is a diagram illustrating an example user-by-user commodity category data 456 stored in the storage 45 of the EC server 40 according to this example embodiment.

The user-by-user commodity category data 456 is generated individually for each user who logs in to the EC site from the PC 50, and stores the login ID of the user who logs in to the EC site from the PC 50, and the commodity category ID in association with each other.

When reading the login code displayed on the PC 50, the terminal 20 accesses the EC site based on the EC site URL that is included in the read login code, and transmits the login token, and the commodity category ID to the EC server 40. Next, after the PC 50 is caused to log in to the EC site, the commodity information collector of the EC server 40 stores the commodity category ID received from the terminal 20 in the user-by-user commodity category data 456 in association with the login ID of the user of the PC 50.

FIG. 32 is a diagram illustrating an example data structure of commodity category collection data 457 stored in the storage 45 of the EC server 40 according to this example embodiment.

Stored in the commodity category collection data 457 are the commodity category ID, a commodity category name, and a total number of persons, in association with each other.

The commodity information collector of the EC server 40 collects, based on the user-by-user commodity category data 456 that is generated individually for each user who logs in to the EC site from the PC 50, the login IDs stored in association with the commodity category ID for each commodity category ID. Next, the number of collected login IDs is set as the total number of persons, and such a total number is stored in the commodity category collection data 457.

[Advantageous Effect of Third Example Embodiment]

The third example embodiment discloses a structure in which the login code includes the commodity category ID to identify the commodity category provided by the EC server 40.

An example advantageous effect accomplished by such a structure is that the terminal can read, by the code reader, the code information including the information related to the classification of the information provided by the first server. Moreover, the first server can transmit, to the display apparatus, the code information including the information related to the classification of the information provided by the first server, and cause the display apparatus to display such code information.

Moreover, the third example embodiment discloses a structure in which the login code includes information that is different at least for each page of the commodity category to display the login code.

An example advantageous effect accomplished by such a structure is that the terminal can read, by the code reader, the code information that includes information that is different at least for each classification-by-classification page for the information provided by the first server to display the code information. Moreover, the first server can transmit, to the display apparatus, the code information including the information that is different at least for each classification-by-classification page for the information provided by the first server to display the code information, and cause the display apparatus to display such code information.

Furthermore, the third example embodiment discloses a structure in which the EC server 40 executes a collection regarding the categories of the commodity to be sold by the EC server 40 based on the information that is included in the login code.

An example advantageous effect accomplished by such a structure is that the first server can grasp the tendency regarding from which classification the users of the terminals often obtain the information among the pieces of information provided by the first server.

### Third Modified Example (1)

According to the third example embodiment, although the commodity category ID to identify each commodity category is stored in association with each commodity category, the present disclosure is not limited to this example. The commodity ID to store each commodity may be stored in association with each commodity instead of the commodity category.

In this case, the code generator 415 may generate the login code that includes the commodity ID. Next, after the PC 50 is caused to log in to the EC site, the EC server 40 may store the commodity ID received in advance from the terminal 20 with the login ID of the user of the PC 50, and may collect the login IDs stored in association with the commodity ID for each commodity ID.

Still further, instead of displaying the login code on the login page, the login code may be displayed on the page that displays the commodity categories, and the page that displays the individual commodity. That is, the login code that includes the commodity category ID generated by the code generator 415 may be displayed on the page that displays the commodity category with the commodity category ID, or the login code that includes the commodity ID generated by the code generator 415 may be displayed on the page that displays the commodity with the commodity ID.

[Advantageous Effect of Third Modified Example (1)]

This modified example discloses a structure in which the login code includes the commodity ID to identify the commodity provided by the EC server 40.

An example advantageous effect accomplished by such a structure is that the terminal can read, by the code reader, the code information that includes the information related to the information provided by the first server. Moreover, the first server can transmit, to the display apparatus, the code information that includes the information related to the information provided by the first server, and cause the display apparatus to display such code information.

Moreover, this modified example illustrates a structure in which the login code includes the information that is different at least for each page of the individual commodity to display the login code, or for each commodity page that displays the login code.

An example advantageous effect accomplished by such a structure is that the terminal can read, by the code reader, the code information that includes the information that is different at least for each information-by-information page provided by the first server to display the code information, or for each information-by-information page provided by the first server and displaying the code information. Moreover, the first server can transmit, to the display apparatus, the code information that includes the information that is different at least for each information-by-information page provided by the first server to display the code information, or for each information-by-information page provided by the first server and displaying the code information, and cause the display apparatus to display such code information.

Furthermore, this modified example discloses a structure in which the EC server 40 executes a collection regarding the commodities to be sold by the EC server 40 based on the information that is included in the login code.

An example advantageous effect accomplished by such a structure is that the first server can grasp the tendency regarding which information the users of the terminals often obtain among the pieces of the information provided by the first server.

### Third Modified Example (2)

According to the third example embodiment, a collection for information related to websites other than the EC site can be executed. Although such a website is not limited to any particular website, not as a limitation but as an example, a server that provides a video site (referred to as a “video providing server” below) may be taken as the first server.

The video site provided by the video site is, not as a limitation but as an example, a website which distributes plural kinds (or plural categories) of videos, and which is the video site that enables the user to give a comment based on the login. Next, the video site providing server detects, using the similar scheme to that of the third example embodiment, with which video among the plural kinds of videos being displayed (with which video page being displayed) the login to the video site is made, and collects the detection results.

For example, the video site providing server generates the login code by the similar scheme to that of the above-described example embodiment. At this time, the video site providing server stores, in association with the kind of the video in advance, a video kind ID to identify the kind of each video. For example, the video kind IDs are stored for broad category by category, such as “animation”, “movie”, “music”, “sports”, and “game”, or for narrowed category by category, such as “soccer”, “baseball”, “golf”, and “basketball”, in the category “sports”.

Next, when the login operation is given with the video site being displayed on the PC 50 and the login request is received from the PC 50, the video site providing server generates the login code that includes the video kind ID stored in association with the kind of the video that is being displayed on the PC 50.

When reading the login code displayed on the PC 50, the terminal 20 accesses the video site based on the video site URL that is included in the read login code, and transmits, to the video site providing server, the login token and the video kind ID. Next, after the PC 50 is caused to log in to the video site, the video site providing server stores the video kind ID received from the terminal 20 in association with the login ID of the user of the PC 50, and collects the pieces of stored data for the plurality of users of the terminals 20. Hence, the total number of persons who log in to the video site is calculated for each kind of the video.

[Advantageous Effect of Third Modified Example (2)]

This modified example discloses a structure in which the login code includes the video kind ID to identify the kind of the video (or the page of such a video) provided by the video site providing server.

An example advantageous effect accomplished by such a structure is that the video site providing server (not as a limitation but as an example first server) receives the identification information related to the kind of the video included in the read code information from the terminal that reads the code information by the code reader, and associates with, for example, the information related to the user authentication of the user of the terminal, thereby grasping the tendency regarding with which kind of video the user of the terminal being watching the login is often made to the video site.

Note that the first server that executes the collection as the above-described example is not limited to the video site providing server that provides the video site. In addition to such a server, various servers which provide the website that can be viewed by the users and which provides the website that needs a login for viewing, such as, not as limitations but as examples, an electronic bulletin board providing server which provides an electronic bulletin board so-called Bulletin Board System (BBS), a blog providing server which provides blogs like individual blogs, and a posting-based site providing server which provides a posting-based site, may be adopted as the first server according to the present disclosure to execute the similar collection to that of the above example.

### Fourth Example Embodiment

A fourth example embodiment accompanies with the first example embodiment, and the business operator of the EC server 40 and the user of the terminal 20 execute a friend registration. Note that the same structure as that of the first example embodiment will be denoted by the same reference numeral, and the description thereof will be omitted.

The details described in the fourth example embodiment are applicable to each of the other example embodiment.

[Functional Constitution]

In this example embodiment, the control device 11 of the IMS server 10 includes, in addition to the functional components illustrated in FIG. 9, a friend management processor.

The friend management processor has a function to execute a process to manage information relating the other user (referred to as a “friend” below) having the mutual friendship relation set in the IMS.

In this example embodiment, the storage 15 of the IMS server 10 stores, in addition to the information illustrated in FIG. 10, a friend management database 157.

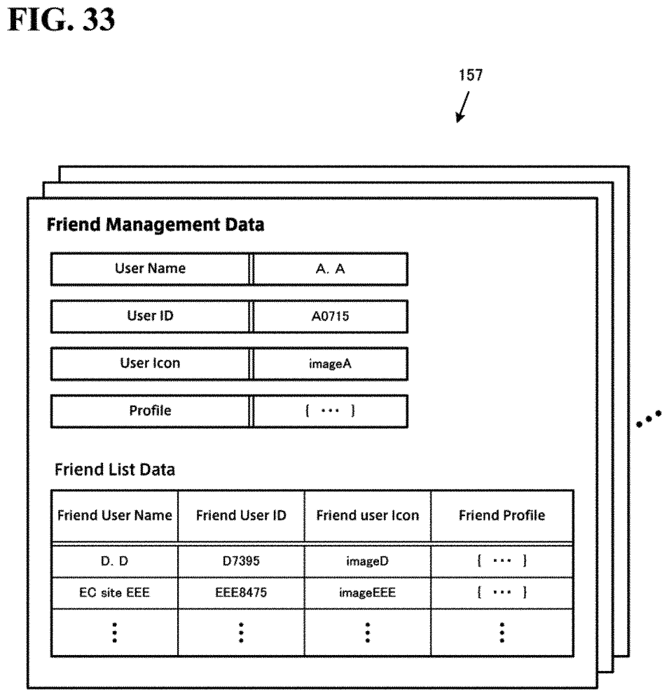

The friend management database 157 stores friend management data utilized by the friend management processor of the control device 11 to manage the friend, and FIG. 33 illustrates an example data structure thereof.

The friend management data is stored in the friend management database 157 for each user of the plurality of terminals 20 utilizing the IMS.

Stored in the friend management data related to each user are the user name of the user, the user ID of the user, the user icon that is the image data related to the icon registered by the user, a number of friends that is the total number of the user's friends, and friend list data.

Stored in the friend list data are friend user names which are data related to the list of the users who become a friend with the user and which are the user names of the users who become a friend with the user, friend user IDs which are the user IDs of the respective users who become a friend, friend user icons which are the image data related to the respective icons registered by the users who become a friend, and respective profiles registered by the users who become a friend, in association with each other.

Moreover, according to this example embodiment, the business operator (the company EEE) of the EC server 40 is registered as an IMS user in the IMS server 10 in advance. The user information related to the business operator of the EC server 40 is stored in the IMS user data 152, and information for the IMS authentication related to the business operator of the EC server 40 is stored in the IMS authentication management data 153.

[Processes]

According to this example embodiment, in the operation B29 of the login management processing executed by the login management processor 413 of the EC server 40 in the first example embodiment, the login OK notification is also transmitted to the IMS server 10 in addition to the terminal 20 and the PC 50.

In the IMS server 10, the friend management processor of the control device 11 transmits, to the terminal 20 by the communication I/F 14, a friend registration confirmation screen to confirm whether or not to execute the friend registration with the business operator of the EC server 40 when receiving the login OK notification from the EC server 40.

The login assist processor 213 of the terminal 20 displays the friend registration confirmation screen within the IMS application that is being executed when receiving the friend registration confirmation screen by the communication I/F 22 from the IMS server 10. Next, when the user permits the friend registration with the business operator of the EC server 40 within the friend registration confirmation screen, the login assist processor 213 transmits, to the IMS server 10 by the communication I/F 22, a friend registration request that requests the friend registration with the business operator of the EC server 40 by the communication I/F 22.

When the IMS server 10 receives the friend registration request from the terminal 20 by the communication I/F 14, the friend management processor of the control device 11 executes a friend registration process. For example, the user name, the user ID, the user icon, and the profile stored in the IMS user data 152 of the storage 15 in association with the IMS user information (the terminal phone number and the terminal mail address) received in the operation B23 of IMS user information providing process are stored in the friend management data. Moreover, the user ID, the user icon, and the profile included in the user information related to the business operator of the EC server 40 stored in the IMS user data 152 are stored in the friend list data included in the friend management data as the friend user name, the friend user ID, the friend user icon, and the friend profile, respectively.

[Display Screen]

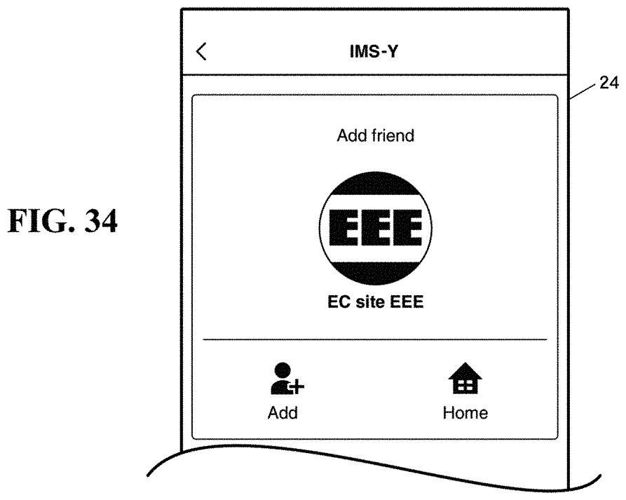

FIG. 34 is a diagram illustrating an example friend registration confirmation screen displayed on the display device 24 of the terminal 20 according to this example embodiment.

This friend registration confirmation screen is an example friend registration confirmation screen displayed within the application that is “IMS-Y”, and displays, together with a message “adding friend”, “EC site EEE” that is the name of the business operator of the EC server 40 (the name of the EC site) to be registered as a friend, and the image of the user icon registered by the business operator of the EC server 40. An “add icon” to add the business operator of the EC server 40 as a friend is displayed therebelow. When this add icon is tapped by the user of the terminal 20, the business operator of the EC server 40 is registered as a friend.

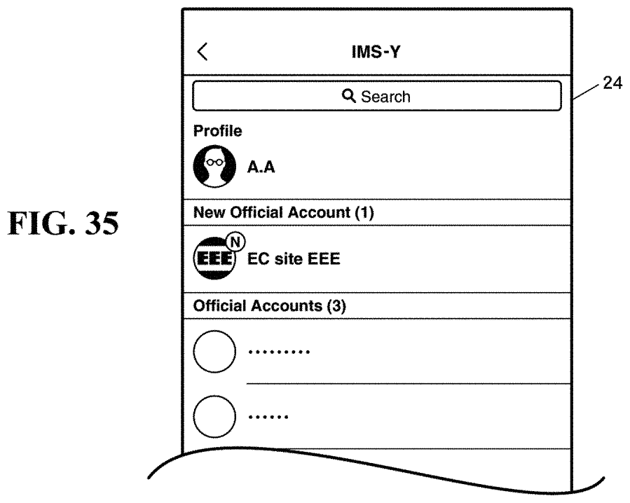

FIG. 35 is a diagram illustrating an example friend list screen displayed on the display device 24 of the terminal 20 according to this example embodiment.

This friend list screen is an example friend list screen displayed within the application that is “IMS-Y”, and the profile is displayed on the upper part of the screen in association with the user name “A. A” of the user of the terminal 20. Moreover, the image of the user icon for the “EC site EEE” to which a marking “N (New)” indicating as new is attached is displayed therebelow as a “new official account”.

[Advantageous Effect of Fourth Example Embodiment]

The fourth example embodiment discloses a structure in which, in the IMS server 10, the user ID related to the business operator of the EC server 40, and the user ID related to the user of the terminal 20 are associated as friends based on the fact that the login code displayed on the PC 50 is read by the IMS application code reader of the terminal 20. Next, in the terminal 20, the information related to the friend registration between the business operator of the EC server 40 and the user of the terminal 20 is displayed on the display device 24.

An example advantageous effect accomplished by such a structure is that the terminal can inform the user of the terminal that the information related to the business operator of the first server and the information related to the business operator of the second server for the service that manages the user information utilized for the user authentication by the first server are associated with each other.

### Fourth Modified Example

In the fourth example embodiment, the user is caused to select the IMS in which the business operator of the EC server 40 becomes a friend. For example, in the terminal 20, when, not as a limitation but as an example, the login OK notification is received from the EC server 40, the control device 21 causes the display device 24 to display a screen to select the IMS in which the business operator of the EC server 40 becomes a friend (referred to as a “friend registration IMS selection screen” below), and causes the user to select the IMS in which the business operator of the EC server 40 becomes a friend. Next, the control device 21 transmits, to the IMS server 10 of the IMS selected by the user, the friend registration request that requests the friend registration with the business operator of the EC server 40.

In this case, at the terminal 20, the sequence (the priority) of the IMS icons displayed on the above-described friend registration IMS selection screen can be changed in accordance with which IMS application code reader the login code is read to log in to the EC server 40. For example, the control device 21 of the terminal 20 stores, not as a limitation but as an example, the record information by the IMS application code reader that reads the login code in past in the storage 28. Next, it is preferable that the control device 21 sets in such a way that, regarding the IMS, the higher the number of times or the frequency utilized for login is, the higher position in the sequence the IMS icon of such an IMS is to be displayed based on the record information that is stored in the storage 28.

Note that, in contrast to the above example, regarding the IMS, the lower the number of times or the frequency utilized for login is, the higher position in the sequence the IMS icon of such an IMS is to be displayed.

Moreover, the EC server 40 statistically analyzes the tendency regarding which IMS is often utilized for login by identifying the IMS of the code reader which reads the login code based on the information that is transmitted from each terminal 20 and by collecting the identification results for the terminals 20 of the plurality of users. Next, the collection and analysis results may be transmitted to the terminal 20 of each user from the EC server 40 to change the sequence (the priority) of the IMS icons displayed on the friend registration IMS selection screen.

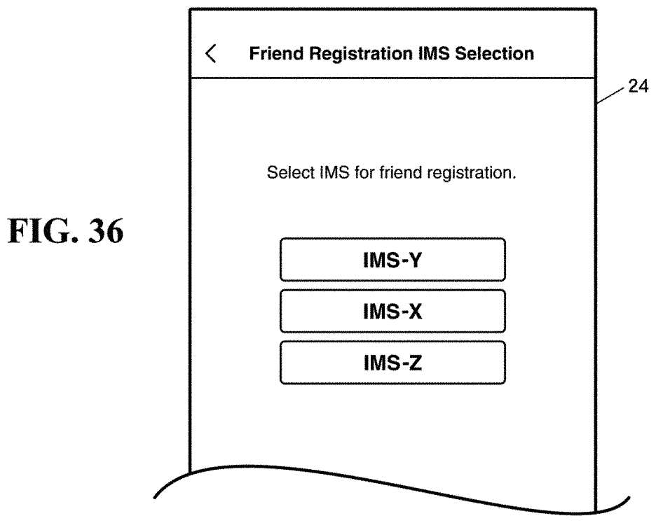

FIG. 36 is a diagram illustrating an example friend registration IMS selection screen displayed on the display device 24 of the terminal 20 according to this modified example.

IMS icons corresponding to three IMS that are “IMS-X”, “IMS-Y”, and “IMS-Z”, are arranged in the vertical direction and displayed in this friend registration IMS selection screen together with a message “select IMS for friend registration”. When any one of the IMS icons is tapped by the user, the friend registration request that requests the friend registration with the business operator of the EC server 40 is transmitted to the IMS server 10 of the IMS corresponding to the tapped IMS icon.

What is characteristic is that, these three IMS icons are not displayed in the sequence of “IMS-X”, “IMS-Y”, and “IMS-Z” from the top, but are displayed in the sequence of “IMS-Y”, “IMS-X”, and “IMS-Z” from the top. This is because that the “IMS-Y” has the login code read most often times, the “IMS-X” has such a code read second most often times, and the “IMS-Z” has such a code read fewest times.

Note that although the description has been given of the example in which the friend registration is executed by the “IMS”, as described above, since the IMS can be also regarded as a form (species) of the SNS, the above-described friend registration may be executed as the SNS instead of the IMS.

[Advantageous Effect of Fourth Modified Example]

This modified example discloses a structure in which the screen to cause the user to select the IMS in which the business operator of the EC server 40 becomes friend is displayed on the display device 24 of the terminal 20 based on the information related to the code reader that reads the login code.

An example advantageous effect accomplished by such a structure is that the user of the terminal can select the business operator of the second server to be associated with the business operator of the first server.

Moreover, this modified example discloses a structure in which the sequence (the priority) of the IMS to be displayed is changed based on the IMS application code reader that reads the login code displayed on the PC 50.

An example advantageous effect accomplished by such a structure is that, at the terminal, the service that has a high utilized frequency by the user can be preferentially displayed, thereby improving the user friendliness.

### Fifth Example Embodiment

A fifth example embodiment accompanies with the first example embodiment, and an advertisement related to the business operator of the EC server 40 (or an advertisement related to the EC), and an advertisement related to the business operator of the IMS server 10 (or an advertisement related to the IMS) is displayed on the display area of the terminal 20 or the website provided by the EC server 40. Four advertisement display patterns (display methods) by the combination thereof can be thought.

The details described in the fifth example embodiment are applicable to each of the other example embodiments.

(A) A pattern in which an advertisement related to the business operator of the EC server (or the advertisement related to the EC) is displayed on the display area of the terminal

As described above, the terminal 20 accesses the EC site (C11) based on the login code that is read by the code reader which is activated from the IMS application 283. This causes an access record file that includes the URL of the EC site identified from the read login code to be stored in the storage 28 of the terminal 20.

Conversely, advertisement information associated with the business operator is stored in the storage 15 of the IMS server 10 for each URL of the business operator that is an advertiser. When the IMS application program 2831 is executed on the terminal 20, the control device 21 refers to the access record file, and transmits, to the IMS server 10, advertisement confirmation information that includes the URL (the URL of the EC site) included in such access record file. The advertisement confirmation information is information to obtain, from the IMS server 10, the advertisement data related to the business operator corresponding to the URL included in an access record.

The IMS server 10 identifies the business operator corresponding to the URL included in the advertisement confirmation information based on the URL that is included in the received advertisement confirmation information (that is, the URL included in the access record of the terminal 20), and on the URL of each business operator. Next, the data for advertisement associated with the identified business operator is transmitted to the terminal 20 that is the transmission destination of the advertisement confirmation information in the format that can be displayed by the IMS application 283 of the own company.

The terminal 20 displays, when receiving the advertisement data transmitted from the IMS server 10, an advertisement image (can be also referred to as an advertising image) based on the received advertisement data related to the advertisement page of the IMS application 283.

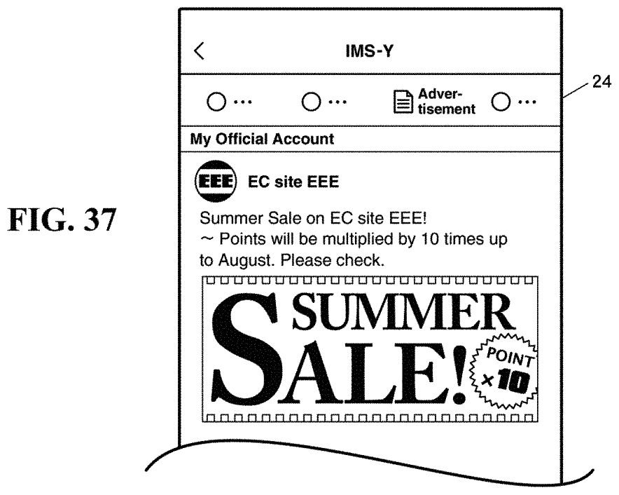

FIG. 37 illustrates an example in which the terminal 20 which reads the login code to log in to the EC site EEE using the code reader of the IMS-Y displays the advertisement image of the EC site EEE on the advertisement page of the IMS-Y displayed on the display device 24 of the terminal 20 based on the execution of the IMS-Y application. In this example, the advertisement image of the EC site EEE that is the advertisement image related to the summer sale on the EC site EEE is displayed.

(B) A pattern in which an advertisement related to the business operator of the IMS server (or an advertisement related to the IMS) is displayed on the website provided by the EC server

Moreover, the EC server 40 can display the advertisement related to the business operator of the identified IMS server 10, or the advertisement related to the IMS on, for example, the EC site of the own company by identifying the IMS associated with the code reader which reads the login code.

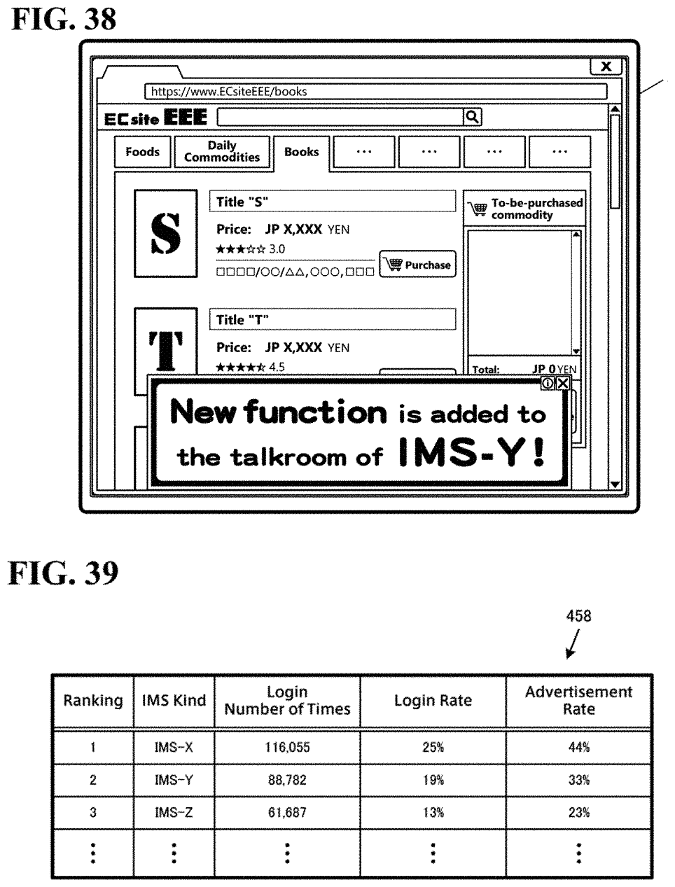

FIG. 38 illustrates an example in which the EC server 40 displays the advertisement related to the IMS-Y on the EC site of the own company when identifying that the login code is read for by the IMS-Y code reader. According to this example, displayed at the lower part of the page of the EC site displayed on the display 53 of the PC 50 after the login is executed based on the login code read by the code reader that is activated from the IMS application of the IMS-Y is an advertisement that notifies the user of an addition of a new function that is a talkroom function of the IMS which is provided by the IMS-Y.

(C) A Pattern in which an Advertisement Related to the Business Operator of the IMS Server (an Advertisement Related to the IMS) is Displayed on the Display Area of the Terminal

In FIG. 37, although the advertisement related to the IMS associated with the code reader which reads the login code is read which is the advertisement related to the business operator of the EC server 40 providing the EC site to which the login is executed (the advertisement related to the EC) is displayed on the advertisement page of the IMS, the present disclosure is not limited to this example.

Not as a limitation but as an example, the advertisement related to the IMS associated with the code reader which reads the login code, e.g., the advertisement illustrated in FIG. 38 may be displayed on the advertisement page of the IMS on the display device 24 of the terminal 20.

(D) A Collection Regarding Advertisement Display

Moreover, the EC server 40 can collect the number of times that the user logs in to the EC site using the code reader associated with the IMS (e.g., the code reader activated from the IMS application for each IMS).

FIG. 39 is a diagram illustrating an example data structure of login statistical data 458 stored in the storage 45 of the EC server 40 according to this example embodiment.

Stored in the login statistical data 458 are the IMS kind to identify the IMS business operator, a login number of times that is the number of times that the login is executed based on the login code read by the code reader corresponding to the IMS kind, a login rate that is a ratio of the login number of times relative to the total login number of times to the EC site, a ranking decided based on the login rate, and an advertisement rate calculated based on the login rate in association with each other.

In the example illustrated in FIG. 39, at the EC server 40, a setting to display the advertisement of the IMS business operator on the EC site of the own company is made for only top three the IMS business operators (X, Y, and Z) that have a high login rate. Hence, the total of the advertisement rates of the top three companies is 100%. The EC server 40 displays the advertisement image of each IMS business operator on the EC site of the own company based on the advertisement rate. The advertisement image of each IMS business operator is obtained in advance from the IMS server 10, and is stored in the storage 45.

Moreover, according to the example illustrated in FIG. 39, the number of times that the login is executed using the code reader of the company X that is the IMS business operator is the highest. Since the percentage of the login number of times of the company X relative to the total of the login number of times of the top three companies is 44%, the EC server 40 displays the advertisement related to the company X on the EC site of the company at the ratio of 44%. Assuming that, for example, 100 times of login are executed to the EC site of the own company, the advertisement related to the company X is displayed on the EC site of own company by 44 times.

[Advantageous Effect of Fifth Example Embodiment]

The advertisement image illustrated in FIG. 37 is displayed on the advertisement page of the IMS as the advertisement provided by the IMS associated with the code reader which reads the login code. Although this advertisement image is an advertisement image related to the business operator of the EC server (the advertisement image related to the EC), it can be also regarded as the advertisement image related to the IMS associated with the code reader.

As described above, the fifth example embodiment discloses a structure in which the advertisement related to the business operator of the EC server 40 (the advertisement related to the EC) is displayed on the display device 24 of the terminal 20 using the IMS associated with the code reader which reads the login code.

An example advantageous effect accomplished by such a structure is that since the advertisement displayed on the display area of the terminal is the advertisement provided by the service associated with the code reader, an opportunity can be increased in which the user of the terminal views the advertisement related to the service by the first server and the advertisement related to the service by the second server.

Moreover, the EC server 40 receives, from the terminal 20, the information related to the IMS application which reads the login code which is the information associated with the IMS application having the code reader activated. Next, as illustrated in FIG. 38, the advertisement related to the IMS identified based on the information related to the code reader is displayed on the EC site.

As described above, the fifth example embodiment discloses a structure in which the advertisement related to the business operator of the IMS server 10 (the advertisement related to the IMS) is displayed on the website provided by the EC server 40 using the identified IMS based on identifying the IMS associated with the code reader which reads the login code by the EC server 40.

An example advantageous effect accomplished by such a structure is that since the advertisement displayed on the website provided by the first server is the advertisement related to the service associated with the code reader, the opportunity that the viewer of the website provided by the first server views the advertisement related to service by the second server can be increased.

Moreover, the fifth example embodiment discloses a structure in which the advertisement related to the IMS associated with the code reader which reads the login code is displayed on the advertisement page of the IMS on the display device 24 of the terminal 20.

An example advantageous effect accomplished by such a structure is that since the advertisement displayed on the display area of the terminal is the advertisement related to the service associated with the code reader, the opportunity that the user of the terminal views the advertisement related to the service by the second server can be increased.

Furthermore, the EC server 40 receives the information related to the code reader which reads the login code from the terminal 20 which reads the login code, and identifies the IMS based on the received information. Next, as illustrated in FIG. 39, the number of times of association with the information related to the code reader (e.g., the number of times that the IMS is utilized for login is collected for each IMS). Consequently, based on the number of times that the IMS is utilized for login, the number of times that the advertisement related to such IMS is displayed on the EC site becomes different for each IMS.

As described above, the fifth example embodiment discloses a structure in which the number of times that the advertisement is displayed on the EC site of the own company is decided for each IMS based on the number of times that such IMS is utilized for login based on identifying the IMS associated with the code reader which reads the login code by the EC server 40.

An example advantageous effect accomplished by such a structure is that the advertisement related to the IMS that has a high frequency utilized by the user of the terminal for the user authentication by the first serve (e.g., the advertisement related to service by the second server that has a high importance for the business operator of the EC server 40 is displayed at a high frequency).

### Fifth Modified Example (1)

(E) A Pattern in which an Advertisement Related to the Business Operator of the EC Server (an Advertisement Related to the EC) is Displayed on the Website Provided by the EC Server

In addition to the advertisement display patterns (A) to (C) described in the fifth example embodiment, a pattern in which the advertisement related to the business operator of EC server 40 (the advertisement related to the EC) is displayed on the website provided by the EC server 40 can be also thought.

In this case, not as a limitation but as an example, the advertisement image illustrated in FIG. 37 may be displayed on the EC site illustrated in FIG. 38.

[Advantageous Effect of Fifth Modified Example (1)]

This modified example discloses a structure in which the advertisement related to the business operator of EC server (the advertisement related to the EC) is displayed on the website provided by the EC server 40.

An example advantageous effect accomplished by such a structure is that the opportunity that the viewer of the website provided by the first server views the advertisement related to service by the first server can be increased.

### Fifth Modified Example (2)

According to the fifth example embodiment, the description has been given of the example in which, in order to display the advertisement on the terminal 20, the advertisement confirmation information based on the access record file stored in the terminal 20 is transmitted to the IMS server 10, but the advertisement may be displayed on the terminal 20 by other schemes.

As described above, the EC server 40 can identify which IMS code reader the login code is read based on receiving, from the terminal 20, the information related to the code reader which reads the login code displayed on the PC 50.

Not as a limitation but as an example, the EC server 40 may display the advertisement related to the EC site of the own company on the display device 24 of the terminal 20 based on the execution of the IMS application of the identified IMS by the terminal 20 which reads the login code.

For example, the EC server 40 identifies the terminal phone number or the terminal mail address of the terminal 20 which reads the login code based on the EC user information stored to the storage 45 or the IMS user information obtained from the IMS server 10. The EC server 40 transmits, to the IMS server 10, advertisement request information to transmit the advertisement data related to the EC site of the own company to the terminal 20 with the identified terminal phone number or the terminal mail address. The advertisement request information includes information that specifies the business operator who is the advertiser of the advertisement, and the identified terminal phone number or terminal mail address.

The IMS server 10 which receives the advertisement request information identifies the advertisement data associated with the business operator specified by the advertisement request information from the advertisement data related to each business operator stored in the storage 15 in advance, and transmits the identified advertisement data to the terminal 20 with the terminal phone number or the terminal mail address included in the advertisement request information in the form that can be displayed by the IMS application of the own company.

The terminal 20 which receives the advertisement data from the IMS server 10 displays the advertisement image based on the received advertisement data related to the advertisement page of the IMS based on the execution of the IMS application of the IMS server 10 (the IMS business operator) that is the transmission destination of the advertisement data.

[Advantageous Effect of Fifth Modified Example (2)]

This modified example discloses a structure in which there is no need for the terminal 20 to store the access record to the EC in order to display the advertisement of the EC site on the terminal 20.

An example advantageous effect accomplished by such a structure is that the advertisement of the website of the first server can be displayed on the display area of the terminal based on the communication between the first server and the second server. Moreover, the terminal does not need to store the access record to the EC site, and does not need to transmit the advertisement confirmation information based on the access record file to the second server. Consequently, the load on the terminal can be reduced.

### Fifth Modified Example (3)

Although FIG. 37 illustrates the example in which the advertisement provided by the IMS associated with the code reader which reads the login code is displayed on the advertisement page of the IMS, the display scheme of the advertisement on the terminal 20 is not limited to this example. Not as a limitation but as an example, based on the friend registration between the business operator of the EC server 40 and the user of the terminal 20 by the IMS server 10 of the IMS associated with the code reader which reads the login code, the IMS server 10 may display the advertisement related to the business operator of the EC server 40 on the talkroom between the business operator of the EC server 40 and the user of the terminal 20.

[Advantageous Effect of Fifth Modified Example (3)]

This modified example discloses a structure in which the advertisement display is executed by utilizing the talkroom function of the IMS utilized for login.

An example advantageous effect accomplished by such a structure is that the opportunity that the user of the terminal views the advertisement related to the business operator of the first server can be increased.

### Fifth Modified Example (4)

Although FIG. 39 illustrates the example in which the EC server 40 decides the number of times that the advertisement related to the IMS is displayed on the EC site for each business operator of the IMS server 10, the present disclosure is not limited to this example. The number of times of displaying the advertisement of the EC site on the terminal 20 of the user by utilizing the IMS operated by such a business operator may be decided for each business operator of the IMS server 10.

For example, regarding FIG. 39, the respective login number of times for X, Y, and Z occupy 44%, 33%, and 23%, respectively, in the total login number of times of the top three companies. The EC server 40 decides, based on these collection results, the advertisement of the EC site of the own company at the rate of 44% (44 times when the advertisement transmission is executed by 100 per a day) on the advertisement page of the IMS by X, at the rate of 33% (similarly, 33 times) on the advertisement page of the IMS by Y, and at the rate of 23% (similarly, 23 times) on the advertisement page of the IMS by Z.

[Advantageous Effect of Fifth Modified Example (4)]

This modified example discloses a structure in which the advertisement related to the EC site of the own company is displayed at a high frequency on the advertisement page of the IMS that has a high frequency utilized by the user for login.

An example advantageous effect accomplished by such a structure is that, for the service by the second server that has a high frequency utilized for the user authentication by the first server, the advertisement related to the business operator of the first server is preferentially displayed.

[Others]

Although various example embodiments according to the present disclosure have been described with reference to various figures and together with modified examples, it should be understood that those skilled in the art can easily carry out various modifications and corrections based on the present disclosure. Hence, such modifications and correction should be within the scope of the present disclosure. Not as a limitation but as an example, functions, etc., in each means and in each operation, etc., can be re-arranged as far as no logical contradiction occurs, and multiple means or operations may be combined as singular means or operation, or may be divided. Moreover, the structural components disclosed in the respective example embodiments can be combined as appropriate.

What is claimed is:

1. An information processing method to be carried out by a terminal, the information processing method comprising:
controlling, by a processor of the terminal, a code reader to read code information displayed on a display device, the code reader corresponding to the code information and installed in the terminal, the code information being for a user authentication enabling obtaining information provided by a first server;
controlling, by the processor, transmission of information related to the code reader to the first server;
controlling, by the processor, reception of information related to a service that manages user information from the first server based on the information related to the code reader;
controlling, by the processor, communication with a second server of the service based on the information related to the service; and
controlling, by the processor, execution of a process related to an authentication of a user of the terminal based on a communication result with the second server.

2. The information processing method according to claim 1, further comprising:
displaying, on a display area of the terminal, information indicating that the user authentication by the first server is executed based on a reception of the information related to the user information by the first server, in accordance with the process related to the authentication of the user of the terminal with the second server.

3. The information processing method according to claim 1, wherein the code information includes access information to access the first server.

4. The information processing method according to claim 3, wherein the code information includes information to transmit, from the terminal to the first server, and the information to transmit is related to the code reader.

5. The information processing method according to claim 1, wherein the code information includes association information to associate the terminal with the display device or to associate the user of the terminal with the display device.

6. The information processing method according to claim 5, further comprising:
controlling, by the processor, a reception of information related to the user information from the second server when the user of the terminal is authenticated by the second server of the service; and
controlling, by the processor, transmission of the information related to the user information to the first server.

7. The information processing method according to claim 6, wherein:
the information related to the user information includes information indicating that the user of the terminal is authenticated by the service; and
the method further comprises controlling, by the processor, transmission of the information indicating that the user of the terminal is authenticated and the association information to the first server.

8. The information processing method according to claim 5, further comprising:
displaying, on a display area of the terminal, indication information indicating that the user authentication is executed by the first server based on a reception of information by the first server, the received information by the first server being related to the user information transmitted from the second server, when the user of the terminal is authenticated by the second server.

9. The information processing method according to claim 8, wherein:
the information related to the user information includes information indicating that the user of the terminal is authenticated by the service; and
the method further comprises displaying, on the display area of the terminal, the indication information based on (i) a reception of information by the first server the information received by the first server being transmitted from the second server and indicating that the user of the terminal is authenticated, and (ii) the association information.

10. The information processing method according to claim 8, further comprising:
displaying, on the display area of the terminal, the indication information based on a reception of information indicating that the user authentication is executed from the second server, when the first server executes the user authentication.

11. The information processing method according to claim 5, wherein the association information is different every time the code information is displayed on the display device.

12. The information processing method according to claim 1, further comprising:
displaying, on a display area of the terminal, a display related to a selection of the service that stores the user information of the terminal when the information related to the service is unidentifiable by the information related to the code reader.

13. The information processing method according to claim 1, wherein the code information includes information related to the information provided by the first server.

14. The information processing method according to claim 13, wherein the code information includes information that is different at least for each page to display the code information or for each page displaying the code information.

15. The information processing method according to claim 1, further comprising:
displaying, on a display area of the terminal, information related to an association between information related to a business operator of the first server and information related to the user of the terminal based on the code information that is read by the code reader.

16. The information processing method according to claim 15, further comprising:
displaying, on the display area of the terminal, information related to the service that associates the information related to the business operator of the first server with the information related to the user of the terminal based on the information related to the code reader.

17. The information processing method according to claim 1, further comprising:
displaying, on a display area of the terminal, an advertisement related to the service associated with the code reader.

18. The information processing method according to claim 1, wherein the code information is information to log in to the first server in order to obtain the information provided by the first server.

19. An information display method to be carried out by the display device configured to display the code information read by the terminal, the terminal configured to perform the information processing method according to claim 1, the information display method comprising:
displaying the code information related to the display device; and
displaying, on the display device, indication information indicating that the user authentication is executed by the first server based on a reception information related to the user information by the first server, in accordance with a process related to an authentication of the user of the terminal with the second server.

20. The information display method according to claim 19, further comprising:
executing a process of inquiring the first server of whether or not the use authentication being executed by the first server.

21. A non-transitory computer-readable recording medium storing a program that, when executed by a processor, causes a terminal including the processor to perform an information processing method, the method comprising:
reading code information displayed on a display device by a code reader corresponding to the code information and installed in the terminal, the code information being for a user authentication enabling obtaining information provided by a first server;
transmitting information related to the code reader to the first server;
receiving information related to a service that manages user information from the first server based on the information related to the code reader;
communicating with a second server of the service based on the information related to the service; and
executing a process related to an authentication of a user of the terminal based on a communication result with the second server.

22. A terminal comprising:
a memory configured to a program; and
one or more processors configured to execute the program such that the one or more processors are configured to cause the terminal to,
read code information displayed on a display device by a code reader corresponding to the code information and installed in the terminal, the code information being for a user authentication enabling obtaining information provided by a first server,
transmit information related to the code reader to the first server,
receive information related to a service that manages user information from the first server based on the information related to the code reader,
communicate with a second server of the service based on the information related to the service, and
execute a process related to the authentication of a user of the terminal based on a communication result with the second server.
